(19) United States
(12) Patent Application Publication
(10) Pub. No.: US 2026/0065129 A1
(43) Pub. Date: Mar. 5, 2026

(54) ADAPTIVE FAIRNESS REPAIR PIPELINE FOR MITIGATING MACHINE LEARNING BIAS

(71) Applicant: Optum Services (Ireland) Limited, Dublin (IE)

(72) Inventors: Daniel KELLY, Donegal (IE); Karim Mahmoud Mohamed MOUSTAFA, Dublin (IE); Harutyun SHAHUMYAN, Dub (IE); Arjit AGRAWAL, Kildare (IE)

(21) Appl. No.: 18/820,759

(22) Filed: Aug. 30, 2024

(51) Int. Cl. G06N 20/00

(52) U.S. Cl. CPC G06N 20/00

(57) ABSTRACT

Various embodiments of the present disclosure provide improved bias mitigation techniques for machine learning technology. The bias mitigation techniques include receiving a machine learning biasing attribute and a set of outputs generated by a target machine learned model and determining a divergence score based at least in part on a difference between a first distribution and a second distribution of the set of outputs. In response to the divergence score meeting or exceeding a threshold, the bias mitigation techniques include generating, using a fairness learning model, a transformation to one or more set of outputs to decrease the divergence score and storing the transformation and an identifier. Through a plurality of iterations, a learned transformation sequence may be generated that may be applied to transform outputs of a machine learning model to mitigate machine learning bias.

### BACKGROUND

Various embodiments of the present disclosure address technical challenges related to machine learning technology, including machine learning bias in supervised machine learning models. Machine learning fairness focuses on ensuring that artificially intelligent algorithms operate without bias, so that no individual or group is disadvantaged or faces prejudiced outcomes. While machine learning systems are never specifically designed to intentionally incorporate bias, they do still have a risk of making predictions that are biased due to replicating or amplifying bias present in real-world data or adding bias as a result of algorithmic design choices or structural features. This may lead to hidden performance deficiencies in machine learning models.

Various embodiments of the present disclosure make important contributions to traditional machine learning bias mitigation techniques by addressing these technical challenges, among others.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and hardware and/or software components for mitigating machine learning bias in accordance with some embodiments discussed herein.

FIG. 5 is an operational example of a divergence score in accordance with some embodiments discussed herein.

FIG. 6 is an operational example of a data structure generated as a result of a first stage of a fairness learning iteration in accordance with some embodiments discussed herein.

FIGS. 7A and 7B are operational examples of a second stage of a fairness learning iteration in accordance with some embodiments discussed herein.

FIG. 8 is a flowchart diagram of an example process for generating a learned transformation sequence in accordance with some embodiments discussed herein.

FIG. 9 is a flowchart diagram of an example process for mitigating bias in a machine learning model in accordance with some embodiments discussed herein.

### DETAILED DESCRIPTION

Various embodiments of the present disclosure provide bias mitigation techniques (e.g., machine(s), hardware and/or software-implemented processe(s)) that improve machine learning technology. Bias, in the context of machine learning outputs, may comprise, for example, more inaccurate outputs (e.g., lower recall) for a subset of input data associated with a particular attribute (e.g., a demographic attribute) associated with the input compared to the accuracy of outputs associated with subset(s) if input data associated with different attribute(s), whether that attribute is explicitly defined in the data provided as input to a machine-learned model or not. Additionally, or alternatively, machine learning bias may refer to outputs that skew towards a particular output or type of output for a subset of inputs associated with a particular attribute in comparison to other subset(s) of input data associated with different attribute(s).

Machine learning bias may be mitigated using one of three mitigation strategies. A first, pre-processing mitigation strategy involves preparing a dataset before the application of a machine learning model. The focus is on creating a fair and representative dataset to ensure that any subsequent model isn't biased due to skewed or partial data. Techniques might include resampling to balance classes, feature selection to remove biased attributes, data augmentation to generate more diverse examples, reweighing instances to minimize discrimination, and/or the like. A second, in-processing mitigation strategy aims to minimize bias during the model training phase. Bias mitigation here might be embedded within the learning algorithm itself. These algorithms adjust the decision boundary during the learning phase to avoid unfairness. A third, post-processing mitigation strategy involves techniques that attempt to correct the bias after the model has been trained. These techniques do not require any modification of the original learning algorithms.

Both pre-processing and in-processing mitigation strategies are problem specific and not generalizable across different machine learning models. While some post-processing strategies may be generalizable within different classes of machine learning models, there is a lack of post-processing mitigation strategies for regression-based models with continuous prediction outputs. Moreover, traditional bias mitigation strategies are limited to a single machine learning biasing attribute (e.g., gender, etc.) and fail to address the intersection of multiple features. This traditional singular focus on mitigating bias may inadvertently introduce new biases into other attributes. Traditional bias mitigation strategies are additionally or alternatively restricted by restrictive data requirements that require labelled training data in order to learn the mitigation parameters. Labelled data is expensive and often new labelled data may not be acquired. Thus, labelled data requirements may force a split between training a machine learning model and learning mitigation parameters requiring a trade-off between prediction generalizability and mitigation generalizability.

To address technical challenges of pre- and in-processing mitigation strategies, some embodiments of the present disclosure provide an iterative fairness learning process and a bias mitigation operation that collectively learn and apply data transformations to machine learning model outputs to mitigate hidden bias within the model. One or more fairness transformations may be generated across one or more respective iterations to iteratively improve a bias of machine learning outputs by decreasing a divergence between probability distributions of outputs generated by a model. This divergence may indicate that input data associated with a more fully represented attribute value, such as “Male,” may be more likely to be accurate/have a higher recall than input data associated with a less represented attribute value, such as “Female.” Iterative reductions in the divergence may be accomplished at a rate determined by a transformation weight that controls a magnitude of the transformations that result in the divergence reduction and iterative applications of fairness transformations may be repeated until a divergence of the distributions is below a divergence threshold. This, in turn, enables an improved bias mitigation technique that directly addresses technical challenges within the realm of machine learning technology.

In some embodiments of the present disclosure, the iterative fairness learning process implements a novel adaptive fairness refinement technique that is designed to specifically address the traditional bias mitigation limitations related to multiple machine learning biasing attributes, continuous target variables, and restrictive data requirements. The novel adaptive fairness refinement technique iteratively identifies bias for a plurality of defined machine learning biasing attributes adjusts a model's outputs (e.g., predictions) to reduce the identified bias. This process is performed iteratively where, for a particular iteration, stepwise adjustments are made to the outputs such that a first probability distribution belonging to a first subgroup of an attribute is made to be more similar to a second probability distribution belonging to a second subgroup of the attribute. For example, an iteration may reduce a divergence score between a distribution of outputs associated with a minority attribute value and a distribution of outputs associated with a majority attribute value.

The iterative fairness learning process provides several technical improvements to traditional machine learning bias mitigation techniques. First, the iterative fairness learning process is generalizable to both classification and regression models across multiple machine learning biasing attributes. Moreover, the iterative fairness learning process may perform mitigation in a highly generalizable way without relying on restrictive data requirements such as requiring labelled data or dividing combinations of machine learning biasing attributes into subgroups. By doing so, the iterative fairness learning process provides a model agnostic solution to improve the fairness of any supervised machine learning model, semi-supervised machine-learned model, and/or unsupervised machine-learned model while simultaneously improving fairness across any combination of defined machine learning biasing attributes, and reducing the time and computational resources to develop and/or deploy a machine-learned model, the likelihood of unfair/biased predictions, and the data requirements needed to implement a bias mitigation process.

Unlike traditional mitigation strategies, the iterative fairness learning process may leverage unlabeled data and does not treat combinations of different features as separate subgroups. By leveraging unlabeled data, as opposed to labeled data, the process increases the number training datasets that may be used for fairness learning and bias mitigation. Meanwhile, by not treating different combinations of features as separate subgroups, the process increases the sample size available to model prediction distributions for machine learning biasing attributes. In some examples, the techniques may overcome difficulties in bias mitigation presented by small samples sizes that may result from dividing features into subgroups. For example, the more rare the feature or combination of features for which bias is to be mitigated, the smaller the sample size and sample variance may be (e.g., the small sample may not accurately reflect adequate diversity to represent a population). This may result in mitigation parameters and/or procedures that overfit the data, causing the mitigation parameters to fit the noise in the sample rather than the underlying distribution, and/or a lower probability that the mitigation parameters are accurately mitigating bias. The techniques discussed herein may increase the accuracy of machine-learned model outputs by accurately and precisely mitigating machine-learning bias. For example, mitigating bias for one or a combination of machine learning biasing attributes may improve the recall for that biasing attribute or combination of biasing attributes that formerly had lower recall compared to other biasing attribute(s) or combination(s) of biasing attributes without causing an outsized reduction in recall for the other biasing attribute(s) or combination(s) combination(s) of biasing attributes.

Examples of technologically advantageous embodiments of the present disclosure include the iterative fairness learning process, the learned transformation sequence, among other aspects of the present disclosure. Other technical improvements and advantages may be realized by one of ordinary skill in the art.

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or, in limited cases, identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may additionally or alternatively be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may additionally or alternatively take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

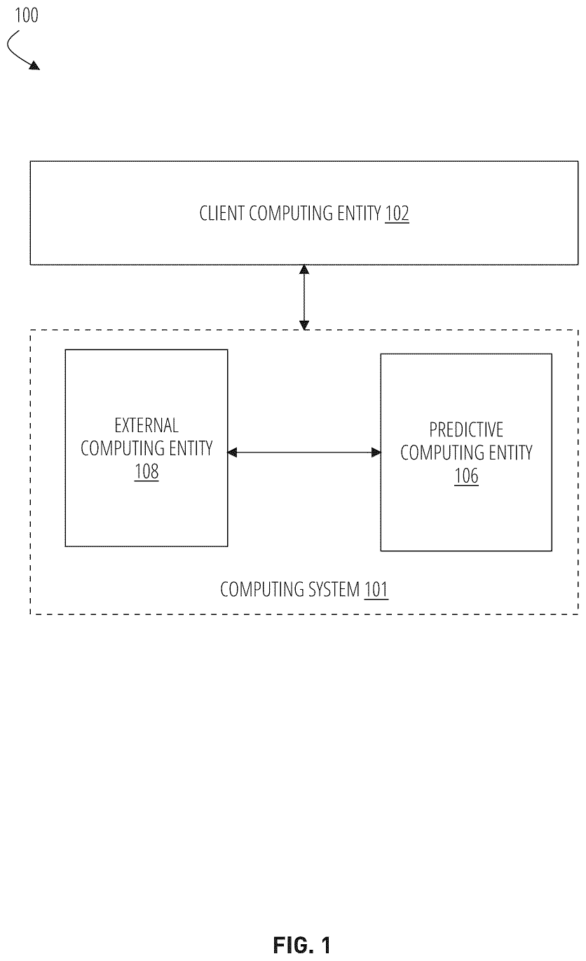

FIG. 1 provides an example overview of an architecture 100 in accordance with some embodiments of the present disclosure. The architecture 100 includes a computing system 101 configured to receive a request, such as fairness fitting requests, from client computing entities 102, process the requests to generate bias assessments, predictions, and/or mitigating data structures, and provide the outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate outputs in various forms, including prediction outputs, quality metrics, learned transformation sequences, and/or the like. The models may form a machine learning pipeline that may be configured to assess, predict, and mitigate machine learning bias. This technique will lead to more accurate and reliable machine learning models that may be efficiently used for a diverse set of different use cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as transformed model outputs, learned transformation sequence, machine learning quality assessment, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may include one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may include one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., bias assessment techniques, bias mitigation techniques, and/or the like) described herein. The external computing entities 108, for example, may include and/or be associated with one or more entities that may be configured to receive, transmit, store, manage, and/or facilitate datasets, such as the evaluation dataset, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

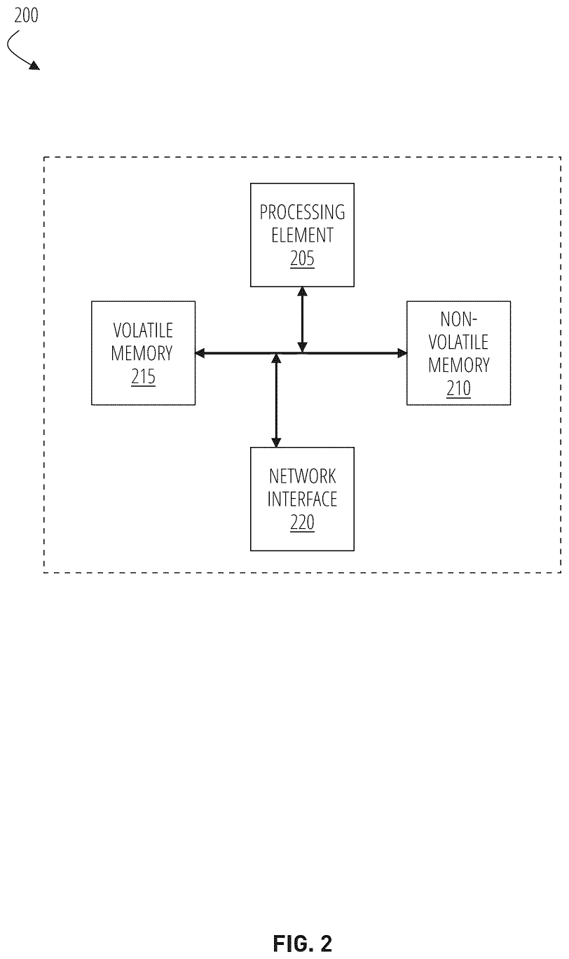

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, which may be one or more predictive computing entities) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (e.g., processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Examples of a combination of hardware and computer program products include application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-transitory computer readable media, such as non-volatile media (e.g., non-volatile storage, memory, memory storage, memory circuitry, and/or similar terms used herein interchangeably) and/or volatile media (e.g., volatile storage, memory, memory storage, memory circuitry, and/or similar terms used herein interchangeably), as discussed above.

As will be recognized, the non-volatile media and/or the volatile media may store respective part(s) of one or more databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

As indicated, in some embodiments, the computing entity 200 may additionally or alternatively include one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. The network interfaces 220, for example, may include one or more wired communication protocols, such as universal serial bus (USB), universal asynchronous receiver/transmitter (UART), IEEE 802.2 (Ethernet), Recommended Standard 232 (RS-232), Recommended Standard 485 (RS-485), and/or the like, and/or one or more wireless communication protocols, such a Wireless Fidelity (Wi-Fi), Bluetooth®, Zigbee®, Z-Wave, and/or the like.

Although not shown, the computing entity 200 may additionally or alternatively include, or be in communication with, one or more input elements/devices, such as input sensor(s). In some examples, the input sensor(s) may include one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively include, or be in communication with, one or more output elements/devices (not shown), such as one or more speakers, visual display devices, haptic feedback devices, motion devices (e.g., electromechanically actuated devices), and/or the like.

### B. Example Client Computing Entity

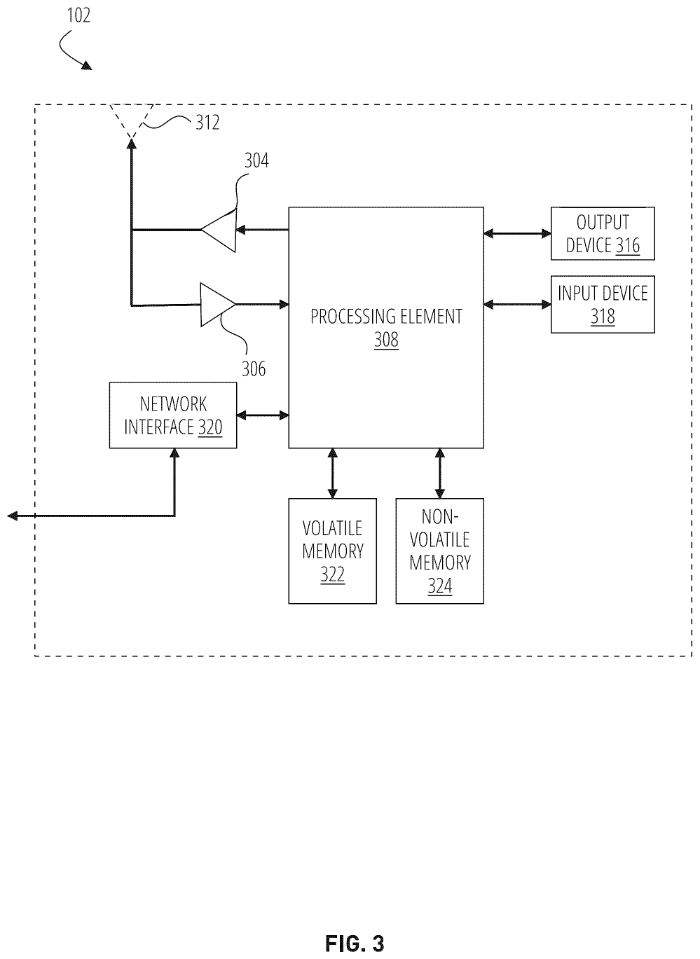

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably.

For example, the client computing entity 102 may include outdoor positioning aspects, such as a location component adapted to acquire, for example, latitude, longitude, altitude, geocode, course, direction, heading, speed, coordinated universal time (UTC), date, and/or various other information/data. In some embodiments, the location component may acquire data, sometimes known as ephemeris data, by identifying the number of satellites in view and the relative positions of those satellites (e.g., using global positioning systems (GPS)). Additionally, or alternatively, location component may acquire triangulation data in connection with a variety of other systems, including cellular towers, WiFi access points, and/or the like. In some examples, outdoor positioning aspects of the present disclosure may be used in a variety of settings to determine the location of someone or something within a geographic environment.

Similarly, the client computing entity 102 may include indoor positioning aspects, such as a location component adapted to acquire, for example, latitude, longitude, altitude, geocode, course, direction, heading, speed, time, date, and/or various other information/data. Some of the indoor systems may use various position or location technologies including radio frequency identification (RFID) tags, active and/or passive radio beacons (e.g., Wi-Fi beacons), and/or the like. In some examples, indoor positioning aspects of the present disclosure may be used in a variety of settings to determine the location of someone or something to within inches or centimeters.

The client computing entity 102 may additionally or alternatively comprise a user interface (that may include an output device 316 (e.g., similar to or different than the output device(s) discussed above) coupled to a processing element 308 and/or a user input device (e.g., an input sensor(s), similar to or different than the input sensor(s) discussed above) coupled to the processing element 308. In some examples, the user interface may additionally or alternatively comprise software component(s) executed by the processing element 308 to present (e.g., audibly, visually, tactilely) via an input and/or output device and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may additionally or alternatively include volatile memory 322 and/or non-volatile memory 324, which may be embedded and/or may be removable.

For example, the non-volatile memory 324 may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as a smart assistant, AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “machine learning fairness fitting request” refers to a data structure that indicates a request to assess and/or correct a bias of a target machine learned model. A machine learning fairness fitting request, for example, may identify a target machine learned model, a plurality of biasing attributes for the model, an evaluation dataset for the target machine learned model, and/or the like. In some examples, the machine learning fairness fitting request is received via a graphical user interface (GUI) and/or a programmatic application programming interface (API) entry point. The machine learning fairness fitting request may include a pointer, link, and/or file that includes and/or references an evaluation dataset, an existing machine learning model, and bias attribute membership data for one or more defined machine learning biasing attributes. Each of these components may be provided, as input, to the fairness learning model to learn a learned transformation sequence for the target machine learned model.

In some embodiments, a machine learning fairness fitting request is provided to the fairness learning model configured to mitigate bias for a target machine learned model. In some examples, the contents of the machine learning fairness fitting request may be based on the target machine learned model. For example, machine learning fairness fitting request may include an evaluation dataset that includes a plurality of validation data objects and a plurality of prediction outputs from the target machine learned model. As discussed herein, the plurality of validation data objects may include unlabeled feature data.

In some embodiments, the term “target machine learned model” refers to a hardware and/or software architecture having one or more parameters (e.g., coefficient(s), weight(s), biase(s), activation function(s) and/or action function type(s) in examples where the activation function and/or function type is determined as part of training, clustering centroid(s)/medoid(s), partition(s)) determined as a result of training the target machine-learned model based at least in part on training hyperparameters and/or structural hyperparameters defining the model's architecture. In some examples, structural hyperparameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), temperature, and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), Kolmogorov-Arnold network(s), clustering algorithm(s), support vector machine(s), etc.

Additional or alternate hyperparameter(s) (i.e., training hyperparameter(s)) may be used as part of training the target machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of the machine-learned model to reduce the loss determined by the loss function, and/or the like. In some examples, the structural hyperparameters and/or the training hyperparameters may be determined by a hyperparameter optimization algorithm or based on user input, such as a software component written by a user or generated by a machine-learned model. The target machine learned model may include any type of model configured, trained, and/or the like to generate a prediction output for a model input. The target machine learned model may include one or more of any type of machine learning model including one or more supervised, unsupervised, semi-supervised, and/or reinforcement learning models. In some embodiments, the target machine learned model may include a single machine-learned model or multiple machine-learned model models configured to perform one or more different stages of a prediction process.

In some embodiments, a target machine learned model is a supervised machine learning model that is pre-trained using one or more supervisory training techniques, such as backpropagation of errors, and/or the like. A target machine learned model may be trained using a labeled training dataset that includes a set of training inputs associated with one or more machine learning biasing attributes and a set of training outputs. In some examples, the labels may comprise partition(s), centroid(s) indicated by a user, class(es), k for use in supervised clustering algorithm training, a ground truth value, a ground truth classification, and/or the like. In an example where the target machine-learned model is a semi-supervised machine-learned model, the training data set may comprise previous input(s) to and/or previous output(s) generated by the target machine-learned model or another machine-learned model. The target machine learned model may be trained based at least in part on providing a first training input of the set of training inputs to the target machine-learned model, determining an output by the target machine-learned model, determining a difference between the output and a first training output of the set of training outputs, determining a loss by a loss function based at least in part on the difference, and altering one or more parameters of the target machine learned model to reduce the loss (e.g., using a loss optimization algorithm, such as gradient descent). In some examples, this process may be iteratively repeated for up to all of the inputs of the set of training inputs, respectively. The target machine learned model, for example, may include a supervised regression model, a classification model, a clustering algorithm, and/or the like that is trained, using a labeled training dataset, to generate a plurality of prediction outputs based on the features (e.g., biasing attribute values and/or non-biasing attribute values) of the training data objects. The prediction outputs may include class probabilities (e.g., for categorical data, etc.), confidence probabilities, binary classifications, and/or the like.

In some embodiments, a target machine learned model is associated with a training dataset and a validation dataset. The training dataset may include a plurality of training data objects; a first training data object of the plurality of training data objects may include one or more attribute values and a training label. The validation dataset may include a plurality of validation data objects; a first validation data object of the plurality of training data objects may include one or more attribute values. In some examples, the validation dataset may additionally or alternatively include an unlabeled dataset or a labeled dataset. In some examples, the target machine learned model may be pretrained using the training dataset and once trained, may be applied to the validation dataset to generate an evaluation dataset that includes the plurality of validation data objects and a plurality of prediction outputs respectively corresponding to the plurality of validation data objects.

In some embodiments, the term “machine learning biasing attribute” refers to an attribute of or associated with a set of data objects used as input to the target machine-learned model that results in a skew of the predicted outputs generated by the target machine-learned model for different subsets of the set of data objects associated with different attribute values. For example, a machine learning biasing attribute may be an attribute where the accuracy, recall, and/or distribution of prediction outputs generated by the target machine-learned model for a first subset input data associated with a first attribute value of a first attribute is significantly different (as determined by the divergence score discussed herein) than the accuracy, recall, and/or distribution of prediction outputs generated by the target machine-learned model for a second subset of input data associated with a second attribute value of the first attribute. . . . For example, an attribute value may be a categorical (e.g., “White”, “Hispanic”; “Muslim”, “Jewish”;), discrete (e.g., binary, such as below/above Federal poverty level; ternary, such as male/female/other, low/medium/high priority), continuous (e.g., a score indicating priority of an issue associated with the object data), or other class associated with an attribute (which may be a label or type, such as “race”, “age range”, “gender”, “triage level”, “triage score”) that is associated with or part of object data. An attribute value may be weighted or otherwise used by a machine learned model (e.g., through a series of inference operations) to generate a prediction output based on a value of the attribute that is exhibited by a data object. Additionally or alternatively, the attribute value is not used as input to the machine-learned model (e.g., such as when the attribute is “age”, the attribute value is “62”, and the data object is other data associated with an individual, but where “62” or “age: 62” is not provided as input to the machine-learned model). In some examples, an attribute may comprise a label such as text (e.g., “gender”, “age range”) and the attribute value may comprise text (e.g., “male”, “female”), a binary number, an integer, a positive integer, a continuous number, a logit, any other identifier, and/or the like.

In some examples, the distribution of prediction outputs may be determined as a probability distribution indicating a likelihood that a prediction output is accurate; a discrete probability distribution indicating a likelihood that, given the same input data but two different attribute values associated with a same attribute, the prediction outputs the machine-learned model would generate from the input data would be the same; and/or the like, any of the distributions of which may be discrete or continuous.

To give a practical, non-limiting example of differences in prediction distributions between prediction outputs associated with different attribute values, the skew in machine-learned model output may result in predicted salaries generally being higher and/or predicted blood pressure values being lower for first input data associated with a first attribute value than predicted salaries and/or predicted blood pressure values associated with second input data associated with a second attribute value. In some examples, a machine learning biasing attribute may include a feature with one or more values that are overrepresented or underrepresented within a training dataset.

In some embodiments, a computing system may detect one or more machine learning biasing attributes based at least in part on probability distributions associated with output of the target machine-learned model for different attribute values. For instance, a feature may be determined to be a machine learning biasing attribute if at least one of the one or more attribute values defined by an attribute is overrepresented or underrepresented by a tolerance threshold (e.g., represented by a percentage (95%, 75%, etc.), a ratio, a maximum/minimum number). In some examples, the one or more machine learning biasing features may be indicated by a machine learning fairness fitting request. As described herein, machine learning biasing attributes are a technical challenge that is unique to machine learning as it impacts the performance of machine learning models in a manner that is not visible to users. Some techniques of the present disclosure are designed to compensate for machine learning bias by detecting and mitigating (e.g., through one or more transformations/alterations of the prediction data output by the machine-learned model) performance defects due to machine learning biasing attributes.

In some embodiments, the term “majority attribute value” refers to an attribute value of a machine learning biasing attribute that is determined to be overrepresented by a training dataset. A majority attribute value, for example, may include a majority group with the largest sample for a given machine learning biasing attribute. A majority attribute value may be used as a reference group (e.g., a group that is reflective of accurate predictions) for that machine learning biasing attribute as there is a higher statistical likelihood that the sample distribution for the majority attribute value is a closer representation to the population distribution compared to other attribute values.

In some embodiments, the term “minority attribute value” refers to an attribute value of a machine learning biasing attribute that is underrepresented by a training dataset. In some examples, a majority attribute value and one or more minority attribute values may be defined for up to each machine learning biasing attribute associated with a machine learning fairness fitting request.

In some embodiments, the term “evaluation dataset” refers to structured and/or unstructured data used to evaluate and/or mitigate performance deficiencies of a target machine learned model. An evaluation dataset may include any type of stored data, including a relational database, a linked list, a graph-based data structure, unstructured data, and/or the like. In some examples, an evaluation dataset may include one or more validation data objects and one or more prediction outputs respectively corresponding to the one or more validation data objects. For example, a first validation data object may include one or more attribute values associated with a respective one or more features. A prediction output may be generated for the first validation data object based on the one or more attribute values by inputting the first validation data object to a target machine learned model and determining the prediction output based at least in part on a set of inference operations executed by the target machine-learned model according to the target machine-learned model's parameters and structural hyperparameters. By way of example, an evaluation dataset may be generated via one or more pre-processing operations in order to generate a plurality of prediction outputs (e.g., prediction probabilities) for input to a fairness learning model. In some examples, the prediction output may be merged with machine learning biasing attribute data (e.g., identifying biasing attribute values, majority/minority attributes, etc.) in order to prepare data for fairness learning, transformation, and/or assessment operations.

The evaluation dataset 402 may include an unlabeled dataset and/or a labeled dataset. For instance, for fairness learning and/or fairness transformation operations, the evaluation dataset 402 may include an unlabeled dataset that may not include ground truth labels for the validation data objects. In addition, or alternatively, for fairness assessment operations, an evaluation dataset 402 may include a labeled dataset with ground truth labels respectively corresponding to at least a subset of the plurality of validation data objects. By using an unlabeled dataset for fairness learning and/or fairness transformation operations, some techniques of the present disclosure improve the generalizability of learned transformations beyond supervised models to semi-supervised and/or unsupervised models.

In some embodiments, the term “fairness learning model” refers to a hardware and/or software architecture having parameters and structural hyperparameters, as discussed similarly above regarding the target machine-learned model. The fairness learning model may include any type of model configured, trained, and/or the like to generate a fairness transformation, a learned transformation sequence, and/or the like. A fairness learning model may include one or more of any type of machine learning model including one or more supervised, unsupervised, semi-supervised, and/or reinforcement learning models. In some embodiments, the fairness learning model may include an unsupervised machine learning model configured to determine an alteration/transformation of one or more prediction outputs over an iterative transformation process.

In some embodiments, the fairness learning model is trained, using the evaluation dataset, to generate a series of transformations to mitigate bias for a target machine learned model. For example, the fairness learning model may receive a plurality of prediction outputs and machine learning biasing attribute membership data from the evaluation dataset. Through a series of iterations, the fairness learning model may learn a series of transformations to mitigate bias in outputs of the target machine learned model. At a first iteration, for example, the fairness learning model may determine a divergence score between distributions of prediction outputs associated with attribute value pairs and detect a repairable distribution pair. The fairness learning model may learn an alteration/transformation to the prediction outputs that reduces the divergence score between the repairable distribution pair by a transformation weight and add the fairness transformation to a learned transformation sequence, which may be applied to current and/or future outputs of the target machine-learned model. For example, the fairness learning model may update the distribution of prediction outputs by altering one or more prediction outputs output by the target machine learned model and associated with the minor attribute group such that the divergence score decreases and may perform another iteration until no repairable distribution pair is detected.

In some embodiments, the term “repairable distribution pair” refers to a data entity comprising two attribute values of a machine learning biasing attribute that are associated with a divergence score that meets or exceeds a divergence score threshold. A repairable distribution pair, for example, may include a first attribute value associated with a majority group and a second attribute value associated with a minority group, where the first attribute value and the second attribute value are associated with the same machine learning biasing attribute. For example, a repairable distribution pair may include a majority attribute value, i, and a minority attribute value, j, that are associated with a divergence score, U_{diverge[i,j]}, that meets or exceeds a divergence score threshold. In some examples, a divergence score is determined for up to each pair of majority and minority attribute values for a machine learning biasing attribute and/or for up to each of a plurality of machine learning biasing attributes. In some examples, the repairable distribution pair determined during an iteration may include the pair of attribute values that are associated with the maximum divergence score from among a plurality of divergence scores determined during the iteration for multiple majority-minority attribute value pairs associated with a machine learning biasing attribute and/or across multiple machine learning biasing attributes.

In some embodiments, the term “divergence score” refers to a value that indicates an extent of divergence/similarity between a distribution of prediction outputs generated by the target machine learned model for a first subset of input data associated with a majority attribute value and a distribution of prediction outputs generated by the target machine learned model for a second subset of input data associated with a minority attribute value. A divergence score, denoted herein as U_{diverge}, may indicate an extent of the divergence/similarity between a pair of groups (e.g., each group including validation data objects with the same attribute value) associated with the same machine learning biasing attribute. A divergence score may be determined for each of one or more and up to all of the machine learning biasing attributes. For a first machine learning biasing attribute, a set of divergence scores, U_{diverge[i,j]}, may be determined based on the similarity between the prediction distribution of a majority attribute value, i, and the prediction distribution(s) of up to each minority attribute value, j. In some examples, a divergence score that is closer to 1 may infer no difference (e.g., a higher similarity) in prediction distributions between the majority and minority attribute value, while a divergence score that is closer to 0 may infer that the prediction distributions are different with no overlap (e.g., a lower similarity). In some examples, a divergence score may indicate a quantile divergence between the prediction distributions of a majority and minority attribute value.

In some embodiments, the term “quantile divergence” refers to a divergence score that indicates a divergence between a portion of a distribution of prediction outputs associated with a majority attribute value and distribution(s) of prediction outputs associated with minority attribute value(s). For example, a quantile divergence may include a percentile ranking of the prediction outputs. For example, a quantile divergence may indicate a divergence score at the 10^{th} percentile, 50^{th} percentile, 90^{th} percentile, and/or any other percentile of the predictions. In terms of the outputs of the model, a divergence score may be a result of subgroups having different proportions of predicted values that meet or exceed a divergence score threshold (e.g., a threshold score determined to be the divergence score at the 90^{th} percentile value).

A divergence score may be determined by determining the difference between two prediction distributions respectively associated with a majority attribute value and minority attribute value. The divergence score may act as a loss metric that the iterative fairness training process may reduce across pairs of attribute values by altering prediction outputs from a target machine learned model. In some examples, the divergence score may be based on an adaptation of the Mann-Whitney U test, which is a non-parametric statistical test used to compare two independent samples to determine whether there is a significant difference between them. Specifically, the statistical test evaluates if, for randomly selected values X and Y from two populations, the probability of X being greater than Y is equal to the probability of Y being greater than X. Explaining this in the context of two prediction distributions, the Mann-Whitney test may determine whether the predicted values for one group are consistently higher or lower than the other. Predicted values that are consistently higher or lower for one group compared to another group may indicate bias in the target machine learned model. Any other suitable distribution comparison technique may be used, such as a generalized linear model (GLM) where the distribution to model is determined based on a goodness of fit (e.g., Bayesian information criterion, Chi-square goodness fit) of a set of distribution types (e.g., Poisson, binomial, negative binomial, uniform, Bernoulli, continuous, t-distribution), permutation t-tests, and/or the like.

In some examples, the divergence score acts as a bounded similarity measure, between 0 and 1, rather than a statistical test. The divergence score, U_{diverge}, determined between a first set of prediction outputs associated with a first attribute value, p_{c=1}, and a second set of prediction outputs associated with a second attribute value, p_{c=2}, may be determined as follows in an adapted Mann-Whitney test. Additionally or alternatively, the Mann-Whitney test may be used on a first probability distribution determined based at least in part on the first set of prediction outputs and a second probability distribution based at least in part on the second set of prediction outputs.

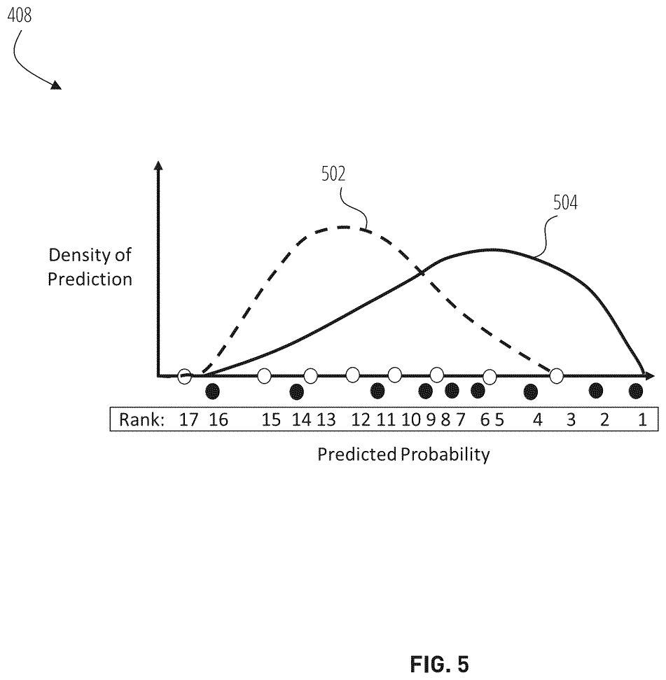

The adapted Mann-Whitney test may comprise ranking all the prediction outputs, regardless of attribute value (i.e., a union of the first prediction outputs and the second prediction outputs) according to a rank directionality. The rank directionality may indicate that rank number increases as prediction output values increase or decrease. The directionality may be heuristically defined (e.g., where the attribute value is associated with a known/preprogrammed directionality, such as ranks increase as predicted salaries increase or ranks increase as predicted blood pressure decreases) or may be programmatically determined. In a programmatic example, the ranking directionality may be determined based on subtracting a mode (e.g., the prediction output at a local maximum in the distribution) of the majority attribute value's prediction distribution from a mode of the minority attribute's prediction distribution. If the result of the subtraction is positive (as it would be for the distributions illustrated in FIG. 5), the prediction outputs may be assigned a rank value that increases as the prediction output value decreases (i.e., the highest prediction output value would be assigned 1), since the prediction outputs associated with the majority attribute value may include values that are generally less than prediction outputs associated with the minority attribute values. Conversely, if the result of the subtraction is negative, the prediction outputs may be assigned a rank value that increases as the prediction output value increases (e.g., the lowest prediction output value would be assigned 1), since the prediction outputs associated with the majority attribute value may include values that are generally less than prediction outputs associated with the minority attribute values. This may be similarly applied to prediction distributions determined as probability distributions. Additionally, or alternatively, the ranking may assign the smallest prediction output a rank of 1 and increase the ranking as the prediction output increases.

Regardless of how the ranking is determined, a sum of the ranks for each set of prediction outputs, p_{c}, may be determined as follows, where Rank

$$( {p}_{c}^{i} )$$

is the rank of the i-th prediction output of the c-th attribute value:

$${Sum}_{c} = {\sum }_{i = 0}^{{N}_{c}} Rank ( {p}_{c}^{i} ) \qquad ( 1 )$$

The Mann-Whitney U value may then be determined for each of the attributes according to:

$${U}_{c} = {Sum}_{c} - \frac{{N}_{c} ( {N}_{c} + 1 )}{2} \qquad ( 2 )$$

where N_{c} is the number of prediction outputs associated with the c-th attribute value. The smaller U value between U_{c=1} and U_{c=2} according to:

$${U}_{stat} = Min ( {U}_{1} {U}_{2} ) \qquad ( 3 )$$

although, in some examples, this operation may be eschewed in examples where the process merely uses U value associated with prediction outputs of the minority attribute value. The divergence score may then be determined according to:

$${U}_{d i verge} = 2 \vert \frac{{U}_{s t a t}}{{N}_{1} {N}_{2}} - \text{.5} ) \vert \qquad ( 4 )$$

where N₁ and N₂ define the number of prediction outputs associated with the first attribute value and the second attribute value.

A divergence score of 1 may indicate that the two distributions are exactly the same, while a value of 0 may indicate that the two distributions are completely separate with no overlap.

In some embodiments, the term “divergence score threshold” refers to a value that defines a criterion for determining a repairable distribution pair. A divergence score threshold, for example, may include a threshold divergence score that defines a minimum divergence score required to determine that a majority attribute value-minority attribute value pair is a repairable distribution pair. In some examples, the divergence score threshold may operate as a stopping condition for an iterative fairness learning process. For example, a new iteration of the iterative fairness learning process may be performed in response to a determining that a divergence score determined for a majority attribute value-minority attribute value pair meets or exceeds the divergence score threshold. If all divergence scores for majority and minority attribute values within an evaluation dataset fail to meet or exceed the divergence score threshold, a repairable distribution pair is not determined, and the iterative fairness learning process ends.

In some examples, the divergence score threshold may be dynamically set based at least in part on a quantile of the divergence scores determined for a plurality of majority attribute value-minority attribute value pairs (e.g., the divergence score threshold may be determined to be the divergence score associated with a 10^{th} percentile, 50^{th} percentile, 80^{th} percentile, 90^{th} percentile, or any other percentile) or may be stored in memory and retrieved at execution. For example, a low divergence score threshold (e.g., a divergence score below 0.01, 0.05, or similar) may result in additional transformations at the expense of time, while a large divergence score threshold (e.g., 0.1, 0.2, or similar) may require less time at the expense of machine learning model accuracy.

In some embodiments, the term “fairness transformation”, “transformation”, or “alteration” (in the context of altering target machine-learned model output(s)) refers to a data structure that indicates one or more operations to alter data. A fairness transformation, for example, may include a data model that may adjust the values of a prediction output. As described herein, a fairness transformation may be trained at each iteration of an iterative fairness learning process to iteratively adjust a distribution of prediction outputs by altering one or more of the underlying prediction output(s) based at least in part on a transformation weight. For example, at a particular iteration of the iterative fairness learning process, a fairness transformation may be learned that lowers the divergence score of a repairable distribution pair by modifying the prediction outputs for a minority attribute value of a repairable distribution pair to more closely align with the prediction outputs for the majority attribute of the repairable distribution pair.

A fairness transformation may be learned through a stepwise iterative process in which (1) a divergence score is determined for the repairable distribution pair and (2) a current fairness transformation is applied to reduce the divergence score. The stepwise iterative process may be performed until the divergence score is reduced until the divergence score is below the divergence score threshold. At each iteration, one or more weights of the fairness transformation may be modified by an optimization algorithm resulting in a fairness transformation that reduces the divergence score based at least in part on a transformation weighted by the transformation weight.

In this manner, a fairness transformation may be learned that reduces the divergence of a repairable distribution pair. By doing so, the fairness transformation may provide incremental improvements over one or more iterations to mitigate machine learning bias without introducing modifications that result in significant changes to other machine learning biasing attributes. For example, each fairness transformation may repair a repairable distribution pair through a partially weighted repair where the fairness transformation is applied to prediction outputs associated with the minority attribute value to increase, decrease, or otherwise transform them by a constant or a function-defined magnitude in a manner that increases the similarity of the minority attribute value's prediction output distribution to the majority attribute value's prediction output distribution. In some examples, the magnitude of the fairness transformation may be defined by a transformation weight (e.g., a weight factor, ω).

A fairness transformation may include one of one or more different transformation types. For each iteration, a fairness transformation of a particular transformation type may be performed on a repairable distribution pair with the aim of minimizing divergences between prediction distributions with respect to the repairable distribution pair. The fairness transformation types may include a normal distribution transformation and/or a quantile transformation. The discussion that follows discusses a normal distribution transformation since it is more familiar, but transformations of other distribution types (e.g., Poisson, binomial, Bernoulli) is contemplated.

In some embodiments, the term “normal distribution transformation” refers to a type of fairness transformation. In some examples, a normal distribution transformation may include a linear shift and/or scaling of the prediction outputs for the repairable distribution pair. For example, a distribution may be a normal distribution represented by mean and standard deviation of the distribution where Aₘₑₐₙ and A_{stddev} are the mean and standard deviation of the distribution of prediction outputs associated with the majority attribute value and Bₘₑₐₙ and B_{stddev} are the mean and standard deviation of the distribution of prediction outputs associated with the majority attribute value. The minority distribution may then be standardized as a standardized distribution, Ā, by subtracting Aₘₑₐₙ from the original distribution, A, and dividing the difference by A_{stddev}, as shown below:

$$\overline{A} = \frac{A - {A}_{m e a n}}{{A}_{s t d d e v}} \qquad ( 5 )$$

A weighted transform is applied to the standardized distribution towards the majority distribution B where the transformation weight, ω, may define (e.g., as a gain) how much A is transformed towards B. The transformed minority distribution, A′, may be determined by:

$${A}^{′} = \overline{A} * {ω}_{m e a n} + {ω}_{stddev} \qquad ( 6 )$$

where:

$${ω}_{m e a n} = ( {B}_{mean} * ω ) + ( {A}_{m e a n} * ( 1 - ω ) ) \qquad ( 7 )$$

$${ω}_{m e a n} = ( {B}_{stddev} * ω ) + ( {A}_{stddev} * ( 1 - ω ) ) \qquad ( 8 )$$

In some embodiments, the term “quantile transformation” refers to a type of fairness transformation. A quantile transformation may include a transformation technique that handles non-normally distributed distributions, such as exponential distributions, beta distributions, multi-modal distributions, and/or the like. A quantile transformation may use quantile normalization to transform one distribution to align quantiles of the distributions (as opposed to the entire distributions). For example, quantiles may be used to divide a distribution into regions of equal probability. Quantile matching is applied to a transformation by mapping each quantile from one distribution to the corresponding quantile in the target distribution. For example, values in the 1st percentile quantile in the source distribution may be mapped to the 1st percentile quantile in the target distribution. The quantile transformation may include several steps, including (1) computing the quantiles for both distributions using a 100 quantile region, a quantile for each percentile 0-100, (2) using an interpolation function to map each quantile of the source distribution to the corresponding quantile in the target distribution, and (3) apply the interpolation function to the source distribution to transform its values. For example, the quantile normalized distribution, A, (e.g., the quantile normalized minority attribute value prediction distribution) may be determined according to:

$${Q}_{A} = C D {F}^{- 1} ( A ) \qquad ( 9 )$$

$${Q}_{B} = C D {F}^{- 1} ( B ) \qquad ( 10 )$$

$$f = {Q}_{A} \to {Q}_{B} \qquad ( 11 )$$

$$\overline{A} = f ( A ) \qquad ( 12 )$$

where CDF⁻¹ is the inverse cumulative distribution function (CDF) used to divide a distribution into regions of equal probability and where f defines the linear interpolation function mapping quantiles from distribution A to quantiles from distribution B.

In some embodiments, a modified quantile mapping technique is leveraged to apply a weighted quantile transformation. For example, a weighted mixture may be applied to the original distribution (e.g., the minority attribute value prediction distribution), A, and the quantile normalized distribution, Ā, based on the transformation weight, w, to determine the transformed distribution, A′:

$${A}^{′} = ( \overline{A} * ω ) + ( A + ( 1 - ω ) ) \qquad ( 13 )$$

In some embodiments, the term “transformation weight” refers to a value that adjusts a magnitude of a transformation accomplished by the fairness transformation.

In some examples, the transformation weight, w, may influence how many iterations of repairable pair detection and repairs it takes for convergence of the iterative fairness learning process. A larger value of the transformation weight, for example, may cause larger transformations to the distribution(s); however, these repairs may negatively affect accuracy and/or recall for other machine learning biasing attributes and possibly fail to converge or may destabilize the prediction outputs (e.g., similar to exploding gradients) resulting in inaccurate prediction output distributions for all or nearly all the prediction outputs. A small value make minor corrections to the distribution, which may result in more iterations to converge and additionally or alternatively could result in converging on a local minimum. The transformation weight, w, for example, may act as a learning rate parameter as part of a gradient descent algorithm. In some examples, the transformation weight may be 0.1, 0.3, 0.4, and/or the like.

In some examples, the transformation weight may be constant or different for different machine learning biasing attributes, may remain the same or change between iterations (e.g., changes to the weight may be scheduled according to a learning rate schedule), and/or the weight may be dynamically determined based at least in part on a change in divergence score accomplished by a last n iterations of transforming the prediction output(s), where n is a positive integer.

In some embodiments, the term “learned transformation sequence” refers to a data structure that indicates one or more fairness transformations to be accomplished in a particular or any order for output(s) of a target machine learned model. A learned transformation sequence, for example, may include a fairness transformation determined at one or more iterations of an iterative fairness learning process. For instance, a fairness transformation may be concatenated to the learned transformation sequence until the iterative fairness learning process ends. A learned transformation sequence may identify both the plurality of fairness transformations and an order for applying the fairness transformations to a model output generated by the target machine learned model, although in some examples, the order may be eschewed.

By way of example, the fairness learning model may store a fairness transformation and an identification of a repairable distribution pair associated therewith after an iteration of the iterative fairness learning process. These one or more transformations and/or identifications may be stored in an order to establish an order in which the transformation may be applied, although in an additional or alternate example, they may be applied in any order, so long as a transformation is applied to the repairable distribution pair for which it was generated. In some examples, the learned transformation sequence may be stored in association with the target machine learned model such that it may be loaded during inference to alter subsequent output(s) of the target machine-learned model using a transformation indicated as being associated with that output (if any).

In some embodiments, the term “bias prediction model” refers to a hardware and/or software architecture having parameters (that may be determined by training the bias prediction model according to a set of training hyperparameters) and/or structural hyperparameters, similarly to the parameters and hyperparameters discussed above regarding the target machine-learned model. The bias prediction model may include any type of model configured, trained, and/or the like to generate a fairness metric for a target machine learned model. A bias prediction model may include one or more of any type of machine learning model including one or more supervised, unsupervised, semi-supervised, and/or reinforcement learning models. In some embodiments, the bias prediction model may include multiple models configured to perform one or more different stages of an assessment process. By way of example, a bias prediction model may include a demographic parity model, an equal opportunity and equalized odds, and/or the like, that are respectively configured to generate a plurality of fairness metrics for a target machine learned model.

In some embodiments, the term “machine learning quality assessment” refers to a data structure that indicates a performance of a machine learning model. A machine learning quality assessment, for example, may include a fairness report that indicates a level of bias exhibited by a machine learning model. Additionally, or alternatively, a machine learning quality assessment may include one or more fairness metrics. The fairness metric(s), for example, may be computed from a range of standard metrics including demographic parity, equal opportunity, equalized odds, and/or the like. In some examples, a machine learning quality assessment may include a report summarizing one or more fairness metrics and/or the level of bias. A machine learning quality assessment may be displayed via a user interface and/or stored in association with a machine learning model.

A machine learning quality assessment may be generated by a quality assessment model configured to apply one or more bias prediction model to data associated with a machine learning model. For example, the quality assessment model may receive the evaluation dataset and/or a plurality of ground truth labels corresponding to the validation data objects of the evaluation dataset. In addition, or alternatively, the quality assessment model may receive data indicative of one or more machine learning biasing attributes and/or a target machine learned model.

In some embodiments, the term “initial machine learning assessment” refers to a machine learning quality assessment that is generated before the performance of an iterative fairness learning process. The initial machine learning assessment, for example, may include a fairness report in which bias is unmitigated by a learned transformation sequence.

In some embodiments, the term “machine learning bias assessment” refers to a machine learning quality assessment that is generated after the performance of an iterative fairness learning process. The machine learning bias assessment, for example, may include a fairness report in which bias is mitigated by a learned transformation sequence.

In some embodiments, the term “model input” or “input data” refers to a data structure input to a target machine learned model. A model input, for example, may include a data object that includes or is associated with one or more attribute values.

In some embodiments, the term “model output” refers to a data structure comprising an unmitigated prediction output generated by a target machine learned model based on a model input.

In some embodiments, the term “transformed model output” refers to a formerly unmitigated prediction output that was transformed using a learned transformation to mitigate bias and improve fairness of the prediction output with respect to one or more machine learning biasing attributes.

By way of example, (i) one or more model outputs generated by the target machine-learned model from one or more model inputs and (ii) data identifying a machine learning biasing attribute associated with the one or more model inputs may be provided to a bias mitigation model to transform the one or more model outputs to mitigate bias. The bias mitigation model may comprise the fairness learning model to determine or identify a previously determined learned transformation or transformation sequence and/or a hardware and/or software component for executing a fairness transformation to the one or more model outputs.

### V. EXAMPLE SYSTEM OPERATIONS

As indicated, various embodiments of the present disclosure make important technical contributions to machine learning bias mitigation technology. In particular, systems and methods are disclosed herein that implement an iterative fairness learning process. By doing so, machine learning bias may be iteratively identified and mitigated in any machine learned model. This, in turn, improves the functionality of various machine learning technologies by improving machine learning performance.

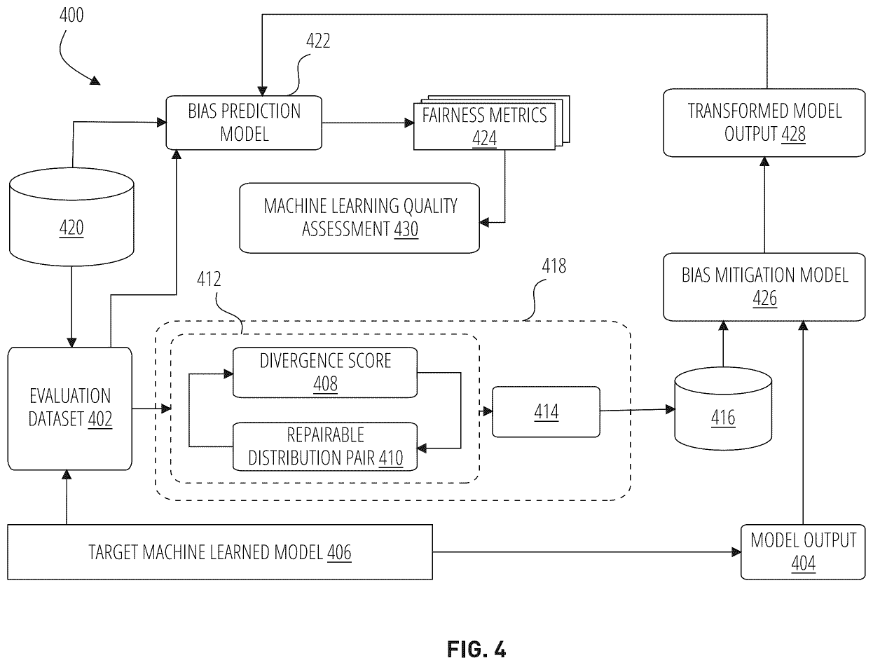

FIG. 4 is a dataflow diagram 400 showing example data structures and hardware and/or software components for mitigating machine learning bias in accordance with some embodiments discussed herein. The dataflow diagram 400, for example, illustrates a multi-stage machine learning bias learning, assessment, and mitigation pipeline. The multi-stage pipeline is configured to iteratively learn machine learning bias in a target machine learned model 406 using an evaluation dataset 402. The bias is learned through an iterative fairness learning process performed by a fairness learning model 418 based on the evaluation dataset 402. Over a plurality of iterations, the fairness learning model 418 may output a learned transformation and/or learned transformation sequence 416 that may be stored in association with the target machine learned model 406. The multi-stage pipeline is configured to apply the learned transformation and/or learned transformation sequence 416 to model outputs 404, using a bias mitigation model 426, to generate a transformed model output 428. The bias mitigation model 426, for example, may apply the learned transformation sequence 416 to model outputs 404 to generate a transformed model output 428. The transformed model output 428 may be used to generate, using one or more fairness metrics 424, a machine learning quality assessment 430 for the target machine learned model 406, which may indicate an original bias before mitigation, a change and/or change over iterations in the bias, and/or a final bias. In this way, the multi-stage pipeline may provide a machine learning-based bias mitigation strategy that holistically processes, learns, and applies machine learning bias for any machine learning technology.

In some embodiments, a machine learning fairness fitting request is received for a target machine learned model 406. The machine learning fairness fitting request may identify (a) one or more machine learning biasing attributes 420 and (b) an evaluation dataset 402 for the target machine learned model 406. The evaluation dataset 402 may include an unlabeled training dataset for the target machine learned model 406. In some examples, the evaluation dataset 402 may additionally or alternatively include one or more prediction outputs generated by the target machine learned model 406 using the unlabeled training dataset. For instance, a machine learning biasing attribute and a set of outputs generated by the target machine learned model 406 may be received (e.g., through the machine learning fairness fitting request). The set of outputs may include a first subset of outputs generated using a first subset of input data associated with a first attribute value and a second subset of outputs generated using a second subset of input data associated with a second attribute value. The first attribute value and the second attribute value may be values of the machine learning biasing attribute.

In some embodiments, the first attribute value is a majority attribute value, and the second attribute value is a minority attribute value. The majority attribute value is an attribute value of a machine learning biasing attribute that is determined to be overrepresented by a training dataset. A majority attribute value, for example, may include a majority group with the largest sample for a given machine learning biasing attribute. A majority attribute value may be used as a reference group (e.g., a group that is reflective of accurate predictions) for that machine learning biasing attribute as there is a higher statistical likelihood that the sample distribution for the majority attribute value is a closer representation to the population distribution compared to other attribute values of the machine learning biasing attribute. The minority attribute value is an attribute value of a machine learning biasing attribute that is underrepresented by a training dataset. In some examples, a majority attribute value and one or more minority attribute values may be defined for up to each machine learning biasing attribute associated with a machine learning fairness fitting request.

In some embodiments, the evaluation dataset 402 includes an unlabeled training dataset for the target machine learned model 406 and the set of outputs generated by the target machine learned model 406 using the unlabeled training dataset. The unlabeled training dataset may include a set of input data including the first subset of input data and a second set of input data associated with at least one of the first attribute value or the second attribute value. The evaluation dataset 402 may include structured and/or unstructured data used to evaluate and/or mitigate performance deficiencies of a target machine learned model 406. The evaluation dataset 402 may include any type of stored data, including a relational database, a linked list, a graph-based data structure, unstructured data, and/or the like. In some examples, the evaluation dataset 402 may include one or more validation data objects and one or more prediction outputs respectively corresponding to the one or more validation data objects. For example, a first validation data object may include one or more attribute values associated with a respective one or more attributes. A prediction output may be generated for the first validation data object based on the one or more attribute values by inputting the first validation data object to the target machine learned model 406 and determining the prediction output based at least in part on a set of inference operations executed by the target machine-learned model 406 according to the target machine-learned model's parameters and structural hyperparameters. By way of example, the evaluation dataset 402 may be generated via one or more pre-processing operations in order to generate a plurality of prediction outputs (e.g., prediction probabilities) for input to the fairness learning model 418. In some examples, the prediction output may be merged with machine learning biasing attribute data (e.g., identifying biasing attribute values, majority/minority attributes, etc.) in order to prepare data for fairness learning, transformation, and/or assessment operations.

In some embodiments, a repairable distribution pair 410 is determined from the evaluation dataset 402. The repairable distribution pair 410 may be determined based on a divergence score 408. In some examples, the divergence score 408 may be determined based at least in part on a difference between a first distribution of the first subset of outputs and a second distribution of the second subset of outputs. In some examples, the repairable distribution pair 410 may be determined based on the divergence score 408 and a divergence score threshold. For example, a repairable distribution pair 410 may be determined in response to a determination that the divergence score 408 for a first and second distribution meets or exceeds a divergence score threshold. In some examples, the divergence score threshold may be based on at least one of a number of iterations preceding a particular iteration, a change in a plurality of divergence scores of a previous n iterations of the altering, where n is a positive integer, a change in an accuracy of one or more prediction outputs associated with the first attribute value, the second attribute value, or a value associated with a second attribute, and/or the like.

In general, the divergence score 408 may include any value that indicates an extent of divergence/similarity between a distribution of prediction outputs generated by the target machine learned model 406 for a first subset of input data associated with a majority attribute value and a distribution of prediction outputs generated by the target machine learned model 406 for a second subset of input data associated with a minority attribute value. The divergence score 408 (e.g., U_{diverge}) may indicate an extent of the divergence/similarity between a pair of groups (e.g., each group including validation data objects with the same attribute value) associated with the same machine learning biasing attribute. During an iteration 412, a divergence score 408 may be determined for each of one or more and up to all of the machine learning biasing attributes. For a first machine learning biasing attribute, a set of divergence scores, U_{diverge[i,j]}, may be determined based on the similarity between the prediction distribution of a majority attribute value, i, and the prediction distribution(s) of up to each minority attribute value, j. In some examples, a divergence score 408 that is closer to 1 may infer no difference (e.g., a higher similarity) in prediction distributions between the majority and minority attribute value, while a divergence score 408 that is closer to 0 may infer that the prediction distributions are different with no overlap (e.g., a lower similarity).

In some embodiments, the divergence score 408 is determined based at least in part on a quantile divergence between a first distribution (e.g., of a majority attribute value) and the second distribution (e.g., of a minority attribute value). A quantile divergence is a divergence score 408 that indicates a divergence between a portion of a distribution of prediction outputs associated with a majority attribute value and distribution(s) of prediction outputs associated with minority attribute value(s). For example, a quantile divergence may include a percentile ranking of the prediction outputs. For example, a quantile divergence may indicate a divergence score 408 at the 10^{th} percentile, 50^{th} percentile, 90^{th} percentile, and/or any other percentile of the predictions. In terms of the outputs of the model, a divergence score 408 may be a result of subgroups having different proportions of predicted values that meet or exceed a divergence score threshold (e.g., a threshold score determined to be the divergence score 408 at the 90^{th} percentile value).

The divergence score 408 may be determined by determining the difference between two prediction distributions respectively associated with a majority attribute value and minority attribute value. The divergence score 408 may act as a loss metric that the iterative fairness training process may reduce across pairs of attribute values by altering prediction outputs from a target machine learned model. In some examples, the divergence score 408 acts as a bounded similarity measure, between 0 and 1, rather than a statistical test. The divergence score 408, U_{diverge}, determined between a first set of prediction outputs associated with a first attribute value, p_{c=1}, and a second set of prediction outputs associated with a second attribute value, p_{c=2}, may be determined where a sum of the ranks for each set of prediction outputs, p_{c}, may be determined as follows, where Rank

$$( {p}_{c}^{i} )$$

is the rank of the i-th prediction output of the c-th attribute value:

$${Sum}_{c} = {\sum }_{i = 0}^{{N}_{c}} Rank ( {p}_{c}^{i} ) \qquad ( 1 )$$

A Mann-Whitney U value may then be determined for each of the attributes according to:

$${U}_{c} = {Sum}_{c} - \frac{{N}_{c} ( {N}_{c} + 1 )}{2} \qquad ( 2 )$$

where N_{c} is the number of prediction outputs associated with the c-th attribute value. The smaller U value between U_{c=1} and U_{c=2} according to:

$${U}_{stat} = Min ( {U}_{1} {U}_{2} ) \qquad ( 3 )$$

although, in some examples, this operation may be eschewed in examples where the process merely uses U value associated with prediction outputs of the minority attribute value. The divergence score 408 may then be determined according to:

$${U}_{d i verge} = 2 \vert \frac{{U}_{s t a t}}{{N}_{1} {N}_{2}} - \text{.5} ) \vert \qquad ( 4 )$$

where N₁ and N₂ define the number of prediction outputs associated with the first attribute value and the second attribute value.

A divergence score 408 of 1 may indicate that the two distributions are exactly the same, while a divergence score 408 of 0 may indicate that the two distributions are completely separate with no overlap.

The repairable distribution pair 410 includes two attribute values of a machine learning biasing attribute that are associated with a divergence score 408 that meets or exceeds a divergence score threshold. The repairable distribution pair 410, for example, may include a first attribute value associated with a majority group and a second attribute value associated with a minority group, where the first attribute value and the second attribute value are associated with the same machine learning biasing attribute. For example, a repairable distribution pair 410 may include a majority attribute value, i, and a minority attribute value, j, that are associated with a divergence score, U_{diverge[i,j]}, that meets or exceeds a divergence score threshold.

The divergence score threshold is a value that defines a criterion for determining a repairable distribution pair 410. A divergence score threshold, for example, may include a threshold divergence score that defines a minimum divergence score required to determine that a majority attribute value-minority attribute value pair is a repairable distribution pair 410. In some examples, the divergence score threshold may operate as a stopping condition for an iterative fairness learning process. For example, a new iteration of the iterative fairness learning process may be performed in response to a determining that a divergence score determined for a majority attribute value-minority attribute value pair meets or exceeds the divergence score threshold. If all divergence scores for majority and minority attribute values within an evaluation dataset fail to meet or exceed the divergence score threshold, a repairable distribution pair 410 is not determined, and the iterative fairness learning process ends.

By way of example, the repairable distribution pair 410 may be determined by a fairness learning model 418 at a first stage of an iterative fairness learning process. For instance, the repairable distribution pair 410 may be determined in a first iteration 412 of a plurality of iterations of the iterative fairness learning process. In some examples, the first stage may be iteratively repeated to iteratively determine another divergence score, determine that the other divergence score meets or exceeds a divergence score threshold, and based on the determination, perform a second stage of the iterative fairness learning process until a stopping condition is reached (e.g., no divergence score meets or exceeds the divergence score threshold).

In some embodiments, the fairness learning model 418 may include any type of model configured, trained, and/or the like to generate a fairness transformation 414, a learned transformation sequence 416, and/or the like. A fairness learning model 418 may include one or more of any type of machine learning model including one or more supervised, unsupervised, semi-supervised, and/or reinforcement learning models. In some embodiments, the fairness learning model 418 may include an unsupervised machine learning model configured to determine an alteration/transformation of one or more prediction outputs over an iterative transformation process, as described herein.

In some embodiments, responsive to determining that a divergence score 408 meets or exceeds a divergence score threshold, the fairness learning model 418 may be used to generate a transformation (e.g., fairness transformation 414) to one or more of the second subset of outputs or the second distribution of the second subset of outputs to decrease the divergence score 408. For example, the fairness transformation 414 may be generated using the fairness learning model 418 based on the repairable distribution pair 410 determined in the first stage of an iteration 412. For example, the fairness transformation 414 may be generated by a fairness learning model 418 at a second stage of the iterative fairness learning process.

In some embodiments, a fairness transformation 414 is generated by responsive to determining that the first attribute value is a majority attribute value based at least in part on determining that the first attribute value is associated with more data objects in an evaluation dataset than data objects associated with one of the second attribute value or any other attribute value (e.g., minority attribute value) associated with the machine learning biasing attribute. The fairness transformation 414 may be generated such that the fairness transformation 414 results in at least one of shifting, scaling, or transforming the second distribution to increase a similarity of the second distribution to the first distribution,

A fairness transformation 414, or transformation, is a data structure that describes one or more logical operations to transform data. The fairness transformation 414, for example, may include a data model that may adjust the values of a prediction output. As described herein, a fairness transformation 414 may be learned at each iteration of an iterative fairness learning process to iteratively adjust one or more prediction outputs, or the distribution of the prediction outputs, to remove reparable distribution pairs. For example, at particular iteration of the iterative fairness learning process, a fairness transformation 414 may be learned that lowers the divergence score 408 of a reparable distribution pair by modifying the prediction outputs for a minority attribute value of a reparable distribution pair 410 to more closely align with the prediction outputs for the majority attribute value of the repairable distribution pair 410.

In some embodiments, fairness transformation 414 is generated based at least in part on a transformation weight that scales a magnitude of the fairness transformation 414. In some examples, the transformation weight, ω, may influence how many iterations of repairable distribution pair detection and repairs it takes for convergence of the iterative fairness learning process. A larger value of the transformation weight, for example, may cause larger transformations to the distribution(s); however, these repairs may negatively affect accuracy and/or recall for other machine learning biasing attributes and possibly fail to converge or may destabilize the prediction outputs (e.g., similar to exploding gradients) resulting in inaccurate prediction output distributions for all or nearly all the prediction outputs. A small value may make minor corrections to the distribution, which may result in more iterations to converge and additionally or alternatively could result in converging on a local minimum. The transformation weight, ω, for example, may act as a learning rate parameter as part of a gradient descent algorithm. In some examples, the transformation weight may be 0.1, 0.3, 0.4, and/or the like.

In some embodiments, the fairness transformation 414 is stored as a portion of a learned transformation sequence 416. For example, the fairness transformation 414 may be stored with an identifier of the first attribute value and the second attribute value. In some examples, a fairness transformation 414 may be stored within the learned transformation sequence 416 after each iteration 412 of the iterative fairness learning process. For example, the second stage, including determining another transformation, may be iteratively repeated until a stopping condition is reached (e.g., no divergence score meets or exceeds the divergence score threshold). In this way, multiple transformations may be stored as a sequence of transformations (e.g., learned transformation sequence 416). As described herein, during inference, a subsequent output of the target machine learned model 406 may be altered using the sequence of transformations (e.g., learned transformation sequence 416).

The learned transformation sequence 416 is a data structure that indicates one or more fairness transformations to be accomplished in a particular or any order for output(s) of a target machine learned model 406. The learned transformation sequence 416, for example, may include a fairness transformation 414 determined at one or more iterations of an iterative fairness learning process. For instance, the fairness transformation 414 may be concatenated to the learned transformation sequence 416 until the iterative fairness learning process ends. A learned transformation sequence 416 may identify both the plurality of fairness transformations and an order for applying the fairness transformations to a model output 404 generated by the target machine learned model 406, although in some examples, the order may be eschewed.

By way of example, the fairness learning model 418 may store a fairness transformation and an identification of a repairable distribution pair 410 associated therewith after an iteration of the iterative fairness learning process. These one or more transformations and/or identifications may be stored in an order to establish an order in which the transformation may be applied, although in an additional or alternate example, they may be applied in any order, so long as a transformation is applied to the repairable distribution pair 410 for which it was generated. In some examples, the learned transformation sequence 416 may be stored in association with the target machine learned model 406 such that it may be loaded during inference to alter subsequent output(s) of the target machine-learned model 406 using a transformation indicated as being associated with that output (if any).

In some embodiments, an updated evaluation dataset is generated by applying the fairness transformation 414 to the evaluation dataset 402. For example, at least one of a transformed second subset of outputs or a transformed second distribution of the second subset of outputs may be generated by altering at least one of the one or more of the second subset of outputs or the second distribution of the second subset of outputs using the transformation 414. A second iteration 412 of the iterative fairness learning process may be performed using the updated evaluation dataset. The iterative fairness learning process may continue until a model convergence is detected. In some embodiments, the model convergence is identified based on the updated evaluation dataset and the divergence score threshold. For example, a model convergence may be identified in the event that an updated evaluation dataset does not include a repairable distribution pair 410.

In some embodiments, the learned transformation sequence 416 is provided for use with the target machine learned model 406. For example, a model input may be received for the target machine learned model 406. Using the target machine learned model 406 a model output 404 may be generated for the model input. The learned transformation sequence 416 may be applied to the model input to generate a transformed model output 428. By way of example, a second set of input data for input to the target machine learned model 406 may be received. The target machine learned model 406 may generate, using the second set of input data, the model output 404. The learned transformation sequence 416 (and/or any number of fairness transformation thereof) may be retrieved based at least in part on determining the second set of input data is associated with at least one of the first attribute value (e.g., a majority attribute value of a repairable distribution pair 410) or the second attribute value (e.g., a minority attribute value of a repairable distribution pair 410) and the model output 404 may be altered by the learned transformation sequence 416 (and/or any number of fairness transformation thereof) as a transformed model output 428.

In some embodiments, the transformed model output is a formerly unmitigated prediction output that was transformed using a learned transformation to mitigate bias and improve fairness of the prediction output with respect to one or more machine learning biasing attributes.

In some examples, (i) one or more model outputs generated by the target machine-learned model 406 from one or more model inputs and (ii) data identifying a machine learning biasing attribute associated with the one or more model inputs may be provided to a bias mitigation model 426 to transform the one or more model outputs to mitigate bias. The bias mitigation model 426 may comprise the fairness learning model 418 to determine or identify a previously determined learned transformation or transformation sequence and/or a hardware and/or software component for executing a fairness transformation to the one or more model outputs.

In some embodiments, an initial machine learning bias assessment is generated for the target machine learned model 406 based on the evaluation dataset 402. The initial machine learning bias assessment, for example, may be generated using one or more bias prediction models 422. In some examples, a current machine learning bias assessment may be generated for the target machine learned model 406 using the learned transformation sequence 416. In some examples, a machine learning quality assessment may be initiated for the target machine learned model 406 based on the initial machine learning bias assessment and the current machine learning bias assessment.

In some embodiments, the machine learning quality assessment 430 includes a data structure that indicates a performance of a machine learning model. A machine learning quality assessment 430, for example, may include a fairness report that indicates a level of bias exhibited by a machine learning model. Additionally, or alternatively, a machine learning quality assessment 430 may include one or more fairness metrics 424. The fairness metric(s) 424, for example, may be computed from a range of standard metrics including demographic parity, equal opportunity, equalized odds, and/or the like. In some examples, a machine learning quality assessment 430 may include a report summarizing one or more fairness metrics 424 and/or the level of bias. A machine learning quality assessment 430 may be displayed via a user interface and/or stored in association with a machine learning model.

In some embodiments, an initial machine learning assessment is a machine learning quality assessment 430 that is generated before the performance of an iterative fairness learning process. The initial machine learning assessment, for example, may include a fairness report in which bias is unmitigated by a learned transformation sequence 416. In some embodiments, the current machine learning biasing assessment is a machine learning quality assessment 430 that is generated after the performance of an iterative fairness learning process. The current machine learning assessment, for example, may include a fairness report in which bias is mitigated by a learned sequence of transformations (e.g., learned transformation sequence 416).

In this manner, a bias within a target machine learned model 406 may be identified, mitigated, and then assessed in a multi-stage pipeline. Through the various operations of the pipeline, divergence scores 408 may be used to both detect and mitigate bias. An example divergence score 408 is described in further detail with reference to FIG. 5.

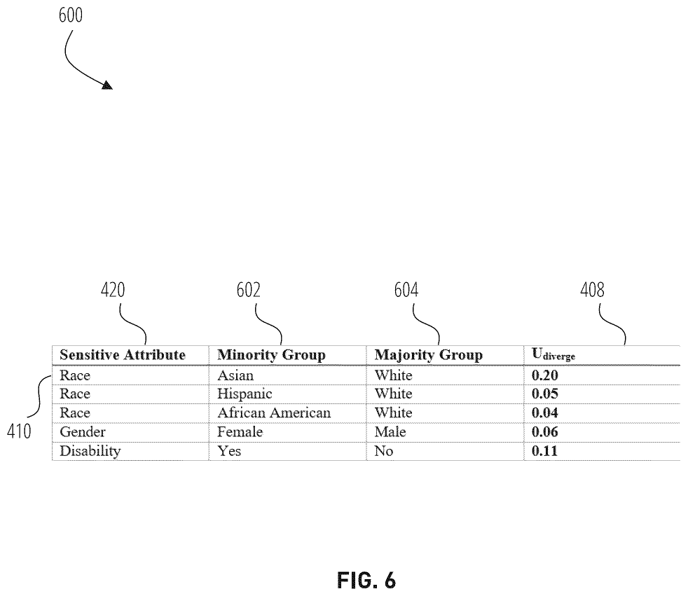

FIG. 5 is an operational example of a divergence score 408 in accordance with some embodiments discussed herein. The divergence score 408 may be based on a comparison between a first prediction distribution 502 associated with a majority attribute value and a second prediction distribution 504 associated with a minority attribute value. As shown, the divergence score 408 may be based on a relative density of prediction probabilities for the majority attribute value and minority attribute value. As described herein, divergence scores 408 may be generated for one or more different machine learning biasing attributes during a first stage of a fairness learning iteration, which is described in further detail with reference to FIG. 6.

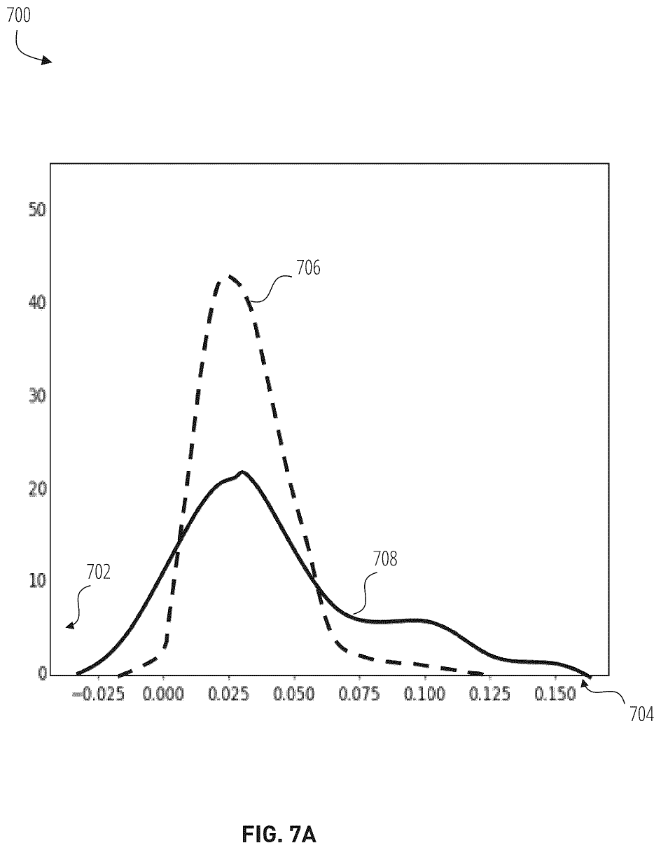

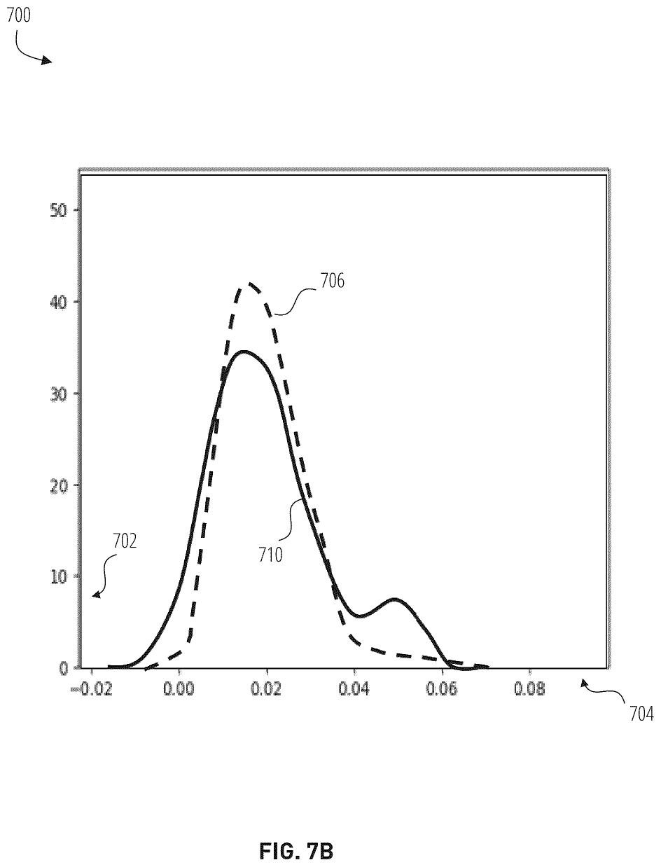

FIG. 6 is an operational example of a data structure 600 generated as a result of a first stage of a fairness learning iteration in accordance with some embodiments discussed herein. As shown, during the first stage of a fairness learning iteration, a plurality of divergence scores 408 may be generated for a plurality of machine learning biasing attributes 420. Each divergence score 408 may correspond to a pair of a single majority attribute value 604 and a single minority attribute value 602 of a machine learning biasing attribute 420. A repairable distribution pair 410 may be determined to be the majority attribute value 604 and minority attribute value 602 pair associated with the maximum divergence score 408. For example, as shown in the sample table, an Asian minority group may have a largest divergence measure, which may be interpreted as members within the Asian group receiving predictions that are most biased. In other words, the Asian-White attribute value pair may be determined to be the repairable distribution pair in this instance. If the divergence score meets or exceeds a divergence score threshold, a second stage of a fairness learning iteration may be performed to mitigate the bias. Operational examples of a second stage are discussed in further detail with reference to FIGS. 7A-B.

FIGS. 7A-B is an operational example of a second stage of a fairness learning iteration in accordance with some embodiments discussed herein. For example, FIGS. 7A-B illustrate an example transformation process 700 in which a transformation 710 is applied to a distribution of a subset of outputs for a repairable distribution pair. The subset of outputs, for example, may include a first subset of outputs 706 corresponding to a majority attribute value of a machine learning biasing attribute and a second subset of outputs 708 corresponding to a minority attribute value of a machine learning biasing attribute. As shown, before the transformation 710 the densities 702 of prediction probabilities 704 of the first subset of outputs 706 and the second subset of outputs 708 may diverge, which may be measured by a large divergence score determined according to the techniques of the present disclosure. Based on the divergence score, a transformation 710 may be generated that, when applied to the second subset of outputs 708, removes and/or reduces the divergence between the first subset of outputs 706 and the second subset of outputs 708.

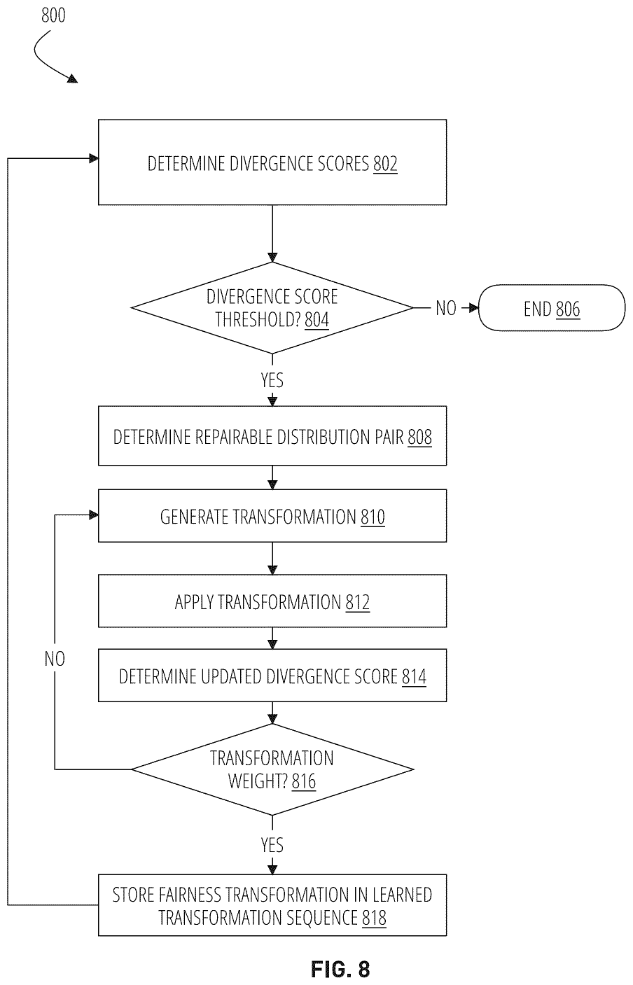

FIG. 8 is a flowchart diagram of an example process 800 for generating a learned transformation sequence in accordance with some embodiments discussed herein. The flowchart depicts an example iterative fairness learning process 800 for mitigating bias in machine learning models. The process 800 may be implemented by one or more computing devices, entities, and/or systems described herein. Any of the one or more computing devices, entities, and/or systems may accomplish all, any one or more, or part of (in coordination with another component) any of the operations discussed herein. For example, via the various steps/operations of the process 800, the computing system 101 may leverage an improved post-processing mitigation strategy to iteratively mitigate bias within a target machine learned model based on prediction distributions of the target machine learned model. By doing so, the process 800 facilitates a bias mitigation technique that is generalizable to both any supervised machine learning model and any combination of machine learning biasing attributes. This, in turn, allows for improved machine learning performance by mitigating bias-related performance defects that traditionally plague machine learning technologies.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some examples, the process 800 may include an iterative, multi-stage process in which a plurality of fairness transformations is generated until a stopping condition is satisfied. In some examples, the process 800 may be initiated in response to receiving a machine learning fairness fitting request that identifies (a) a plurality of machine learning biasing attributes and (b) an evaluation dataset for a target machine learned model. The evaluation dataset may include an unlabeled training dataset for the target machine learned model and a plurality of prediction outputs for the unlabeled training dataset.

In some embodiments, the process 800 includes, at step/operation 802, determining divergence scores. For example, the computing system 101 may determine divergence scores for each of a plurality of machine learning biasing attributes. The plurality of machine learning biasing attributes may identify one or more categorical class attributes and/or one or more binary class attributes. In some examples, each of the plurality of machine learning biasing attributes is associated with a majority attribute value and one or more minority attribute values. A divergence score may be generated for two defined parameter values of each machine learning biasing attribute based at least in part on respective distributions associated with the parameter values. For examples, the two defined parameter values may include a majority attribute value and a minority attribute value of the one or more minority attribute values.

At step/operation 804, the process 800 may compare the divergence scores to a divergence score threshold. If at least one divergence score meets or exceeds the divergence score threshold, the process 800 may proceed to step/operation 808 where a repairable distribution pair is identified for a second stage of the multi-stage process.

Otherwise, the process 800 may detect a stopping condition and proceed to step/operation 804, wherein the process 800 may end. In some embodiments, the computing system 101 may generate an updated evaluation dataset by applying the latest fairness transformation to the evaluation dataset. The computing system 101 may detect a stopping condition based on the updated evaluation dataset and the divergence score threshold. And, in response to detecting the stopping condition, the computing system 101 may provide the learned transformation sequence for use with the target machine learned model.

In some embodiments, the process 800 includes, at step/operation 808, determine a repairable distribution pair. For example, the computing system 101 may determine a repairable distribution pair from the evaluation dataset based on a divergence score determined for two defined parameter values meeting or exceeding a divergence score threshold.

In some embodiments, the process 800 includes, at step/operation 810, generating a fairness transformation. For example, the computing system 101 may generate, using a fairness learning model, a fairness transformation for the target machine learned model based on the respective subsets of prediction outputs associated with the repairable distribution pair, distributions associated with the respective subsets of prediction outputs, and/or a transformation weight.

At step/operation 812, the process 800 may apply the fairness transformation to the evaluation dataset/a subset of the prediction outputs to generate an updated evaluation dataset/subset of the prediction outputs. At step/operation 814, the process 800 may determine an updated divergence score for the updated evaluation dataset/subset of the prediction outputs. At step/operation 816, the process 800 may compare the updated divergence score to a divergence score threshold. Additionally. or alternatively, the updated divergence score may be compared to the original divergence score to determine whether the updated divergence score is an improvement over the original divergence score. If the improvement meets or exceeds a transformation weight, the process 800 may proceed to step/operation 818, where the process 800 includes storing the fairness transformation. Additionally, or alternatively, step/operation 818 may include storing an indication of the attribute value pair for which the fairness transformation was generated in association with the fairness transformation. Otherwise, the process 800 may return to step/operation 810 where a new fairness transformation is generated.

In some embodiments, the process 800 includes, at step/operation 818, storing the fairness transformation in a learned transformation sequence. For example, the computing system 101 may store the fairness transformation as a portion of a learned transformation sequence and return the step/operation 802.

In some embodiments, the repairable distribution pair is identified in a first iteration of a plurality of iterations. The computing system 101 may generate, via the plurality of iterations, a plurality of fairness transformations respectively corresponding to a plurality of repairable distribution pairs. The computing system 101 may generate, via the plurality of iterations, the learned transformation sequence by storing each of the plurality of fairness transformations as a linear sequence of transformations.

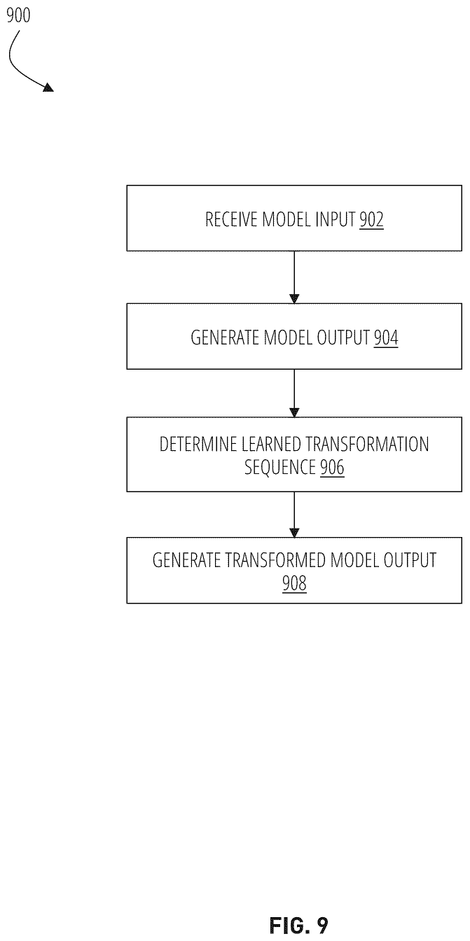

FIG. 9 is a flowchart diagram of an example process 900 for mitigating bias in a machine learning model in accordance with some embodiments discussed herein. The flowchart depicts a bias mitigation technique for improving the performance of various machine learning technologies. The process 900 may be implemented by one or more computing devices, entities, and/or systems described herein. For example, via the various steps/operations of the process 900, the computing system 101 may leverage an improved learned transformation sequence to sequentially modify a model output. By doing so, the process 900 facilitates the generation of transformed model outputs that mitigate hidden bias within a machine learning model. This, in turn, allows for improved machine learning performance.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 includes, at step/operation 902, receiving a model input. For example, the computing system 101 may receive a model input for input to a target machine learned model. In some examples, the model input may include (i.e., where the attribute value is input to the target machine learned model) or be associated with (i.e., where the attribute value is not input to the target machine learned model) an attribute value.

In some embodiments, the process 900 includes, at step/operation 904, generating a model output. For example, the computing system 101 may generate, by the target machine learned model and using the model input, a model output. For example, the computing system 101 may input the model input to the target machine learned model to receive the model output.

In some embodiments, the process 900 includes, at step/operation 906, determining a learned transformation sequence associated with the model input. For example, the computing system 101 may determine a learned transformation or learned transformation sequence that is associated with the attribute value of the model input and the target machine learned model.

In some embodiments, the process 900 includes, at step/operation 908, generating a transformed model output. For example, the computing system 101 may apply the learned transformation or learned transformation sequence to the model output to generate a transformed model output.

In some embodiments, the transformed model output enables the generation of a machine learning quality assessment. For example, the computing system 101 may generate, using one or more bias prediction models, an initial machine learning bias assessment for the target machine learned model based on the evaluation dataset. The computing system 101 may generate, using the learned transformation sequence, an optimized machine learning bias assessment for the target machine learned model. The computing system 101 may initiate the performance of a machine learning quality assessment for the target machine learned model based on the initial machine learning bias assessment and the optimized machine learning bias assessment.

Some techniques of the present disclosure enable the generation of action outputs that may be performed to initiate one or more real world actions to achieve real-world effects. The techniques of the present disclosure may be used, applied, and/or otherwise leveraged to generate a prediction output that may be leveraged to initiate a control of a device via one or more control instructions, and/or the like. Using some of the techniques of the present disclosure, a prediction output may be interpreted to trigger the performance of actions at a client device, such as the display, transmission, and/or the like of data reflective of a machine learning performance, and/or the like. In some embodiments, a prediction output triggers an alert for a user. In addition, or alternatively, the prediction output may trigger (e.g., via one or more control instructions) an action by a robotic device (e.g., by unlocking an ingress/egress point of a building, etc.).

In some examples, the computing tasks may include actions that may be based on a prediction domain. A prediction domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Throughout this specification, components, operations, or structures described as a single instance may be implemented as multiple instances. Although individual operations of one or more methods are illustrated and described as separate operations, one or more of the individual operations may be performed concurrently or otherwise in parallel, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Similarly, the methods or routines described herein may be at least partially processor-executed. For example, at least some of the operations of a method may be performed by one or more processors or processor-executed hardware components. The performance of certain of the operations may be distributed among the one or more processors, not only residing within a single machine, but deployed across a number of machines. In some example embodiments, the processor or processors may be located in a single location (e.g., within a home environment, an office environment, or as a server farm) and/or device, while in other embodiments the processors may be distributed across a number of locations and/or devices. Moreover, each operation of processes illustrated as logical flow graphs may represent a sequence of operations that can be implemented in hardware, software, or a combination thereof.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may additionally or alternatively mean that two or more elements are not in direct contact with each other, but yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment, but not every embodiment necessarily includes the particular element, feature, structure, or characteristic. The appearances of the phrase “in one embodiment” in various places in the specification are not necessarily all referring to the same embodiment, although they may.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one or more elements that are additionally or alternatively elements of a second subset of the set. The first subset may be said to be a subset of the second subset if all the elements of the first subset are elements of the second subset, while additionally or alternatively being a subset of the set. However, if all the elements of the second subset are additionally or alternatively elements of the first subset (in addition to all the elements of the first subset being elements of the second subset), the first subset and the second subset are a single subset/not distinct.

For the purposes of the present disclosure, the term ‘a’ or ‘an’ entity refers to one or more of that entity. As such, the terms ‘a’ or ‘an’, ‘one or more’, and ‘at least one’ can be used interchangeably herein unless explicitly contradicted by the specification using the word “only one” or similar. For example, “a first element” may functionally be interpreted as “a first one or more elements” or a “first at least one of element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or all of the processor(s) (e.g., one or multiple processors in the same device, or multiple processors distributed among multiple devices) contribute to the generation of X and/or Y; and (3) other variations. This similarly applied to any other component or feature similarly recited (e.g., as “a component”, “a feature”, “one or more components”, “one or more features”, “a plurality of components”, “a plurality of features”).

Moreover, any discussion of receiving data associated with an individual that may be protected, confidential, or otherwise sensitive information, is understood to have been preceded by transmitting a notice of use of the data, receiving authorization to use the data, and/or providing a mechanism by which a user may cause use of the data to cease or a copy of the data to be provided to the user.

The patent claims at the end of this patent application are not intended to be construed under 35 U.S.C. § 112 (f) unless traditional means-plus-function language is expressly recited, such as “means for” or “step for” language being explicitly recited in the claim(s).

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method, the computer-implemented method comprising receiving, by one or more processors, a machine learning biasing attribute and a set of outputs generated by a target machine learned model comprising a first subset of outputs generated using a first subset of input data associated with a first attribute value and a second subset of outputs generated using a second subset of input data associated with a second attribute value, wherein the first attribute value and the second attribute value are values of the machine learning biasing attribute; determining, by the one or more processors, a divergence score based at least in part on a difference between a first distribution of the first subset of outputs and a second distribution of the second subset of outputs; determining, by the one or more processors, that the divergence score meets or exceeds a divergence score threshold; responsive to determining that the divergence score meets or exceeds the divergence score threshold, generating, by the one or more processors and using a fairness learning model, a transformation to one or more of the second subset of outputs or the second distribution of the second subset of outputs to decrease the divergence score; storing, by the one or more processors, the transformation and an identifier of the first attribute value and the second attribute value; and generating, by the one or more processors, at least one of a transformed second subset of outputs or a transformed second distribution by altering at least one of the one or more of the second subset of outputs or the second distribution of the second subset of outputs using the transformation.

Example 2. The computer-implemented method of any of the preceding claims, further comprising receiving a second set of input data for input to the target machine learned model; generating, using the target machine learned model and using the second set of input data, a model output; retrieving the transformation based at least in part on determining the second set of input data is associated with at least one of the first attribute value or the second attribute value; and altering the model output by the transformation as a transformed model output.

Example 3. The computer-implemented method of any of the preceding claims, further comprising iteratively repeating a first stage comprising determining another divergence score and determining that the other divergence score meets or exceeds the divergence score threshold and a second stage comprising determining another transformation until a stopping condition is reached; storing multiple transformations as a sequence of transformations; and altering a subsequent output of the target machine learned model using the sequence of transformations.

Example 4. The computer-implemented method of any of the preceding claims, wherein the transformation is further based at least in part on a transformation weight that scales a magnitude of the transformation.

Example 5. The computer-implemented method of any of the preceding claims, wherein the divergence score threshold is based on at least one of a number of iterations preceding a particular iteration; a change in a plurality of divergence scores of a previous n iterations of the altering, where n is a positive integer; or a change in an accuracy of one or more prediction outputs associated with the first attribute value, the second attribute value, or a value associated with a second attribute.

Example 6. The computer-implemented method of any of the preceding claims, further comprising determining that the first attribute value is a majority attribute value based at least in part on determining that the first attribute value is associated with more data objects in an evaluation dataset than data objects associated with one of the second attribute value or any other attribute value associated with the machine learning biasing attribute, wherein the transformation is generated such that the transformation results in at least one of shifting, scaling, or transforming the second distribution to increase a similarity of the second distribution to the first distribution, responsive to determining that the first attribute value is the majority attribute value.

Example 7. The computer-implemented method of claim 6, wherein the divergence score is determined based at least in part on a quantile divergence between the first distribution and the second distribution, wherein the second attribute value is a minority attribute value.

Example 8. The computer-implemented method of any of the preceding claims, wherein an evaluation dataset comprises (i) an unlabeled training dataset for the target machine learned model and (ii) the set of outputs generated by the target machine learned model using the unlabeled training dataset; and the unlabeled training dataset comprises a set of input data comprising the first subset of input data and a second set of input data associated with at least one of the first attribute value or the second attribute value.

Example 9. A system comprising memory and one or more processors communicatively coupled to the memory, the one or more processors configured to receive a machine learning biasing attribute and a set of outputs generated by a target machine learned model comprising a first subset of outputs generated using a first subset of input data associated with a first attribute value and a second subset of outputs generated using a second subset of input data associated with a second attribute value; determine a divergence score based at least in part on a first distribution of the first subset of outputs and a second distribution of the second subset of outputs; determine that the divergence score meets or exceeds a divergence score threshold; responsive to determining that the divergence score meets or exceeds the divergence score threshold, generate, using a fairness learning model, a transformation to one or more of the second subset of outputs or the second distribution of the second subset of outputs to decrease the divergence score; store the transformation and an identifier of the first attribute value and the second attribute value; and generate at least one of a transformed second subset of outputs or a transformed second distribution by altering at least one of the one or more of the second subset of outputs or the second distribution of the second subset of outputs using the transformation.

Example 10. The system of claim 9, wherein the one or more processors are further configured to receive a second set of input data for input to the target machine learned model; generate, using the target machine learned model and using the second set of input data, a model output; retrieve the transformation based at least in part on determining the second set of input data is associated with at least one of the first attribute value or the second attribute value; and alter the model output by the transformation as a transformed model output.

Example 11. The system of any of claims 9 through 10, wherein the one or more processors are further configured to iteratively repeating a first stage comprising determining another divergence score and determining that the other divergence score meets or exceeds the divergence score threshold and a second stage comprising determining another transformation until a stopping condition is reached; storing multiple transformations as a sequence of transformations; and altering a subsequent output of the target machine learned model using the sequence of transformations.

Example 12. The system of any of claims 9 through 11, wherein the transformation is further based at least in part on a transformation weight that scales a magnitude of the transformation.

Example 13. The system of any of claims 9 through 12, wherein the divergence score threshold is based on at least one of a number of iterations preceding a particular iteration; a change in a plurality of divergence scores of a previous n iterations of the altering, where n is a positive integer; or a change in an accuracy of one or more prediction outputs associated with the first attribute value, the second attribute value, or a value associated with a second attribute.

Example 14. The system of any of claims 9 through 13, wherein the one or more processors are further configured to determine that the first attribute value is a majority attribute value based at least in part on determining that the first attribute value is associated with more data objects in an evaluation dataset than data objects associated with one of the second attribute value or any other attribute value associated with the machine learning biasing attribute, wherein the transformation is generated such that the transformation results in at least one of shifting, scaling, or transforming the second distribution to increase a similarity of the second distribution to the first distribution, responsive to determining that the first attribute value is the majority attribute value.

Example 15. The system of claim 14, wherein the divergence score is determined based at least in part on a quantile divergence between the first distribution associated with the majority attribute value and a second distribution associated with a minority attribute value, wherein the second attribute value is the minority attribute value.

Example 16. The system of any of claims 9 through 15, wherein an evaluation dataset comprises (i) an unlabeled training dataset for the target machine learned model and (ii) the set of outputs generated by the target machine learned model using the unlabeled training dataset; and the unlabeled training dataset comprises a set of input data comprising the first subset of input data and a second set of input data associated with at least one of the first attribute value or the second attribute value.

Example 17. One or more non-transitory computer-readable storage media including instructions that, when executed by one or more processors, cause the one or more processors to receive a machine learning biasing attribute and a set of outputs generated by a target machine learned model comprising a first subset of outputs generated using a first subset of input data associated with a first attribute value and a second subset of outputs generated using a second subset of input data associated with a second attribute value; determine a divergence score based at least in part on a first distribution of the first subset of outputs and a second distribution of the second subset of outputs; determine that the divergence score meets or exceeds a divergence score threshold; responsive to determining that the divergence score meets or exceeds the divergence score threshold, generate, using a fairness learning model, a transformation to one or more of the second subset of outputs or the second distribution of the second subset of outputs to decrease the divergence score; store the transformation and an identifier of the first attribute value and the second attribute value; and generate at least one of a transformed second subset of outputs or a transformed second distribution by altering at least one of the one or more of the second subset of outputs or the second distribution of the second subset of outputs using the transformation.

Example 18. The one or more non-transitory computer-readable storage media of claim 17, wherein the one or more processors are further caused to receive a second set of input data for input to the target machine learned model generate, using the target machine learned model and using the second set of input data, a model output; retrieve the transformation based at least in part on determining the second set of input data is associated with at least one of the first attribute value or the second attribute value; and alter the model output by the transformation as a transformed model output.

Example 19. The one or more non-transitory computer-readable storage media of any of claims 17 through 18, wherein the divergence score is determined based at least in part on a quantile divergence between the first distribution associated with a majority attribute value and a second distribution associated with a minority attribute value.

Example 20. The one or more non-transitory computer-readable storage media of any of claims 17 through 19, wherein the one or more processors are further caused to determine that the first attribute value is a majority attribute value based at least in part on determining that the first attribute value is associated with more data objects in an evaluation dataset than data objects associated with one of the second attribute value or any other attribute value associated with the machine learning biasing attribute, wherein the transformation is generated such that the transformation results in at least one of shifting, scaling, or transforming the second distribution to increase a similarity of the second distribution to the first distribution, responsive to determining that the first attribute value is the majority attribute value.

Example 21. The computer-implemented method of example 1, wherein the target machine learned model is a supervised neural network and the method further comprises receiving labelled training data for the target machine learned model, wherein the labelled training data comprises a plurality model input and corresponding ground truths; and training the machine learning model by using one or more supervised training techniques.

Example 22. The computer-implemented method of example 21, wherein the training is performed by the one or more processors.

Example 23. The computer-implemented method of example 1, wherein the one or more processors are included in a first computing entity; and the training is performed by one or more other processors included in a second computing entity.

Example 24. The system of example 11, wherein the one or more processors are further configured to receive training data for the target machine learned model and train the target machine learned model using the training data.

Example 25. The system of example 11, wherein the one or more processors are included in a first computing entity; and the target machine learned model is trained by one or more other processors included in a second computing entity.

Example 26. The one or more non-transitory computer-readable storage media of example 18, wherein the instructions further cause the one or more processors to train the target machine learned model.

Example 27. The one or more non-transitory computer-readable storage media of example 18, wherein the one or more processors are included in a first computing entity; and the target machine learned model is trained by one or more other processors included in a second computing entity.

What is claimed is:

1. A computer-implemented method comprising:
receiving, by one or more processors, a machine learning biasing attribute and a set of outputs generated by a target machine learned model comprising a first subset of outputs generated using a first subset of input data associated with a first attribute value and a second subset of outputs generated using a second subset of input data associated with a second attribute value, wherein the first attribute value and the second attribute value are values of the machine learning biasing attribute;
determining, by the one or more processors, a divergence score based at least in part on a difference between a first distribution of the first subset of outputs and a second distribution of the second subset of outputs;
determining, by the one or more processors, that the divergence score meets or exceeds a divergence score threshold;
responsive to determining that the divergence score meets or exceeds the divergence score threshold, generating, by the one or more processors and using a fairness learning model, a transformation to one or more of the second subset of outputs or the second distribution of the second subset of outputs to decrease the divergence score;
storing, by the one or more processors, the transformation and an identifier of the first attribute value and the second attribute value; and
generating, by the one or more processors, at least one of a transformed second subset of outputs or a transformed second distribution by altering at least one of the one or more of the second subset of outputs or the second distribution of the second subset of outputs using the transformation.

2. The computer-implemented method of claim 1, further comprising:
receiving a second set of input data for input to the target machine learned model;
generating, using the target machine learned model and using the second set of input data, a model output;
retrieving the transformation based at least in part on determining the second set of input data is associated with at least one of the first attribute value or the second attribute value; and
altering the model output by the transformation as a transformed model output.

3. The computer-implemented method of claim 1, further comprising:
iteratively repeating a first stage comprising determining another divergence score and determining that the other divergence score meets or exceeds the divergence score threshold and a second stage comprising determining another transformation until a stopping condition is reached;
storing multiple transformations as a sequence of transformations; and
altering a subsequent output of the target machine learned model using the sequence of transformations.

4. The computer-implemented method of claim 1, wherein the transformation is further based at least in part on a transformation weight that scales a magnitude of the transformation.

5. The computer-implemented method of claim 1, wherein the divergence score threshold is based on at least one of:
a number of iterations preceding a particular iteration;
a change in a plurality of divergence scores of a previous n iterations of the altering, where n is a positive integer; or
a change in an accuracy of one or more prediction outputs associated with the first attribute value, the second attribute value, or a value associated with a second attribute.

6. The computer-implemented method of claim 1, further comprising:
determining that the first attribute value is a majority attribute value based at least in part on determining that the first attribute value is associated with more data objects in an evaluation dataset than data objects associated with one of the second attribute value or any other attribute value associated with the machine learning biasing attribute,
wherein the transformation is generated such that the transformation results in at least one of shifting, scaling, or transforming the second distribution to increase a similarity of the second distribution to the first distribution, responsive to determining that the first attribute value is the majority attribute value.

7. The computer-implemented method of claim 6, wherein the divergence score is determined based at least in part on a quantile divergence between the first distribution and the second distribution, wherein the second attribute value is a minority attribute value.

8. The computer-implemented method of claim 1, wherein:
an evaluation dataset comprises (i) an unlabeled training dataset for the target machine learned model and (ii) the set of outputs generated by the target machine learned model using the unlabeled training dataset; and
the unlabeled training dataset comprises a set of input data comprising the first subset of input data and a second set of input data associated with at least one of the first attribute value or the second attribute value.

9. A system comprising memory and one or more processors communicatively coupled to the memory, the one or more processors configured to:
receive a machine learning biasing attribute and a set of outputs generated by a target machine learned model comprising a first subset of outputs generated using a first subset of input data associated with a first attribute value and a second subset of outputs generated using a second subset of input data associated with a second attribute value;
determine a divergence score based at least in part on a first distribution of the first subset of outputs and a second distribution of the second subset of outputs;
determine that the divergence score meets or exceeds a divergence score threshold;
responsive to determining that the divergence score meets or exceeds the divergence score threshold, generate, using a fairness learning model, a transformation to one or more of the second subset of outputs or the second distribution of the second subset of outputs to decrease the divergence score;
store the transformation and an identifier of the first attribute value and the second attribute value; and
generate at least one of a transformed second subset of outputs or a transformed second distribution by altering at least one of the one or more of the second subset of outputs or the second distribution of the second subset of outputs using the transformation.

10. The system of claim 9, wherein the one or more processors are further configured to:
receive a second set of input data for input to the target machine learned model;
generate, using the target machine learned model and using the second set of input data, a model output;
retrieve the transformation based at least in part on determining the second set of input data is associated with at least one of the first attribute value or the second attribute value; and
alter the model output by the transformation as a transformed model output.

11. The system of claim 9, wherein the one or more processors are further configured to:
iteratively repeating a first stage comprising determining another divergence score and determining that the other divergence score meets or exceeds the divergence score threshold and a second stage comprising determining another transformation until a stopping condition is reached;
storing multiple transformations as a sequence of transformations; and
altering a subsequent output of the target machine learned model using the sequence of transformations.

12. The system of claim 9, wherein the transformation is further based at least in part on a transformation weight that scales a magnitude of the transformation.

13. The system of claim 9, wherein the divergence score threshold is based on at least one of:
a number of iterations preceding a particular iteration;
a change in a plurality of divergence scores of a previous n iterations of the altering, where n is a positive integer; or
a change in an accuracy of one or more prediction outputs associated with the first attribute value, the second attribute value, or a value associated with a second attribute.

14. The system of claim 9, wherein the one or more processors are further configured to:
determine that the first attribute value is a majority attribute value based at least in part on determining that the first attribute value is associated with more data objects in an evaluation dataset than data objects associated with one of the second attribute value or any other attribute value associated with the machine learning biasing attribute,
wherein the transformation is generated such that the transformation results in at least one of shifting, scaling, or transforming the second distribution to increase a similarity of the second distribution to the first distribution, responsive to determining that the first attribute value is the majority attribute value.

15. The system of claim 14, wherein the divergence score is determined based at least in part on a quantile divergence between the first distribution associated with the majority attribute value and a second distribution associated with a minority attribute value, wherein the second attribute value is the minority attribute value.

16. The system of claim 9, wherein:
an evaluation dataset comprises (i) an unlabeled training dataset for the target machine learned model and (ii) the set of outputs generated by the target machine learned model using the unlabeled training dataset; and
the unlabeled training dataset comprises a set of input data comprising the first subset of input data and a second set of input data associated with at least one of the first attribute value or the second attribute value.

17. One or more non-transitory computer-readable storage media including instructions that, when executed by one or more processors, cause the one or more processors to:
receive a machine learning biasing attribute and a set of outputs generated by a target machine learned model comprising a first subset of outputs generated using a first subset of input data associated with a first attribute value and a second subset of outputs generated using a second subset of input data associated with a second attribute value;
determine a divergence score based at least in part on a first distribution of the first subset of outputs and a second distribution of the second subset of outputs;
determine that the divergence score meets or exceeds a divergence score threshold;
responsive to determining that the divergence score meets or exceeds the divergence score threshold, generate, using a fairness learning model, a transformation to one or more of the second subset of outputs or the second distribution of the second subset of outputs to decrease the divergence score;
store the transformation and an identifier of the first attribute value and the second attribute value; and
generate at least one of a transformed second subset of outputs or a transformed second distribution by altering at least one of the one or more of the second subset of outputs or the second distribution of the second subset of outputs using the transformation.

18. The one or more non-transitory computer-readable storage media of claim 17, wherein the one or more processors are further caused to:
receive a second set of input data for input to the target machine learned model;
generate, using the target machine learned model and using the second set of input data, a model output;
retrieve the transformation based at least in part on determining the second set of input data is associated with at least one of the first attribute value or the second attribute value; and
alter the model output by the transformation as a transformed model output.

19. The one or more non-transitory computer-readable storage media of claim 17, wherein the divergence score is determined based at least in part on a quantile divergence between the first distribution associated with a majority attribute value and a second distribution associated with a minority attribute value.

20. The one or more non-transitory computer-readable storage media of claim 17, wherein the one or more processors are further caused to:
determine that the first attribute value is a majority attribute value based at least in part on determining that the first attribute value is associated with more data objects in an evaluation dataset than data objects associated with one of the second attribute value or any other attribute value associated with the machine learning biasing attribute,
wherein the transformation is generated such that the transformation results in at least one of shifting, scaling, or transforming the second distribution to increase a similarity of the second distribution to the first distribution, responsive to determining that the first attribute value is the majority attribute value.
